(19) United States
(12) Patent Application Publication
(10) Pub. No.: US 2024/0010058 A1
(43) Pub. Date: Jan. 11, 2024

(54) Assembly and cover system for a vehicle roof, and vehicle roof for a motor vehicle

(71) Applicant: Webasto SE, Stockdorf (DE)

(72) Inventors: Ulrich SCHREIBER, Stockdorf (DE); Julian KNÖPFLE, Stockdorf (DE); Maciej KACZMAREK, Stockdorf (DE); Moritz PRADELLA, Stockdorf (DE); Johann LANG, Stockdorf (DE)

(21) Appl. No.: 18/035,017

(22) PCT Filed: Oct. 25, 2021
(86) PCT No.: PCT/EP2021/079516

§ 371 Date: May 2, 2023

(30) Foreign Application Priority Data
Nov. 6, 2020 (DE) 102020129281.3
Feb. 4, 2021 (DE) 102021102618.0

(51) Int. Cl. B60J 7/16; E05F 15/63

(52) U.S. Cl. CPC B60J 7/1642; E05F 15/63; E05Y 2201/702; E05Y 2201/70; E05Y 2900/542

(57) ABSTRACT

An assembly for a vehicle roof having a cover for forming a deployable for the roof, and an inner cover panel which is coupled to the cover. The assembly also has a cover frame configured for coupling the cover to a roof bodywork of the motor vehicle. The assembly also has a cover receiving unit configured for receiving the cover and coupling it to the cover frame; and a tilt mechanism which is coupled firstly to the inner cover panel and secondly to the cover frame, and which is configured for moving the cover between a first retracted position and a second deployed position. The assembly moreover has an electric drive unit coupled directly to the tilt mechanism so that the cover can be electrically moved between the first and second position by the tilt mechanism and the drive unit without the use of the drive cable.

### CROSS-REFERENCE TO RELATED APPLICATIONS

This application is a U.S. national phase application filed under 35 U.S.C. § 371 of International Application No. PCT/EP2021/079516, filed on Oct. 25, 2021, published under WO 2022/096305 on May 12, 2022, designating the United States, which claims priority from German Patent Application Number 10 2020 129 281.3, filed on Nov. 6, 2020, and from German Patent Application Number, 10 2021 102 618.0, filed on Feb. 4, 2021, which are hereby incorporated herein by reference in their entirety for all purposes.

### FIELD

The invention concerns an assembly for a vehicle roof. The invention furthermore concerns a cover system and a vehicle roof with such an assembly.

### BACKGROUND

Some motor vehicles have vehicle roofs with one or more covers, which for example, as a fixedly integrated glass element, allow a clear view through the vehicle roof or, as movably formed components, allow optional opening and closing of an opening in the vehicle roof. In production of such a vehicle roof, roof modules are connected to a bodywork of the motor vehicle by means of a frame. Forming a vehicle roof is described for example in document EP 2020367 A2.

### SUMMARY

It is an object of the present invention to create an assembly for a vehicle roof which allows a simple and low-cost construction of a vehicle roof and also contributes to good visibility through the vehicle roof. A further object is to create a cover system and a vehicle roof with such an assembly.

These objects are achieved by the features of the respective independent patent claims. Advantageous refinements are given in the dependent claims.

An assembly according to the invention for a vehicle roof for a motor vehicle comprises a cover, an inner cover panel and a cover frame. The cover is provided for forming a deployable and retractable roof element for the vehicle roof. The inner cover panel is coupled to the cover, and the cover frame is configured for coupling the cover to a roof bodywork of the motor vehicle. The assembly furthermore comprises a cover receiving unit which is configured for receiving the cover and coupling it to the cover frame. The assembly furthermore comprises a tilt mechanism which is coupled firstly to the inner cover panel and secondly to the cover frame. The tilt mechanism is configured for moving the cover between a first retracted position and a second deployed position. Also, the assembly comprises an electric drive unit which is coupled directly to the tilt mechanism so that the cover can be electrically moved between the first and second positions by the tilt mechanism and the drive unit without the use of a drive cable.

By means of the described assembly, in a simple and economic fashion, a vehicle roof construction can be achieved which allows particularly good visibility through the vehicle roof. In particular, by means of the described assembly, the tilt mechanism and the drive unit, a clear and reliable concept for deploying and retracting the cover with integrated drive can be provided. This can be achieved with a lower number of necessary components, and therefore requires little installation space and can be produced at low cost.

According to a refinement of the assembly, the drive unit is configured as or comprises a spindle drive with a motor and a driving spindle. By means of the spindle, the drive unit is coupled directly to the tilt mechanism. Alternatively, other motor designs for the drive unit possible.

According a further refinement of the assembly, the drive unit comprises a gear mechanism, by means of which the drive unit can be coupled directly to the tilt mechanism. Accordingly, the torque transferred between a motor shaft of the drive unit and the tilt mechanism can be reduced or increased.

Also, the assembly may be configured such that it is coupled to the tilt mechanism by means of a push-fit or clutch element.

According to a further refinement of the assembly, the tilt mechanism and the drive unit are mounted in a common holder. Here, the drive unit may form a separate assembly which is arranged in a holder of the tilt mechanism, or may have a separate holder in which the tilt mechanism is also arranged. Alternatively, the drive unit forms a separate assembly which is attached to a mounting of the tilt mechanism.

According to a further refinement of the assembly, the drive unit is coupled to the cover frame at a side longitudinal web thereof relative to a longitudinal axis of the vehicle roof. In particular, the drive unit and the tilt mechanism may be compactly installed in a rear corner of the cover frame and hence only slightly restrict the visibility through the vehicle roof.

Terms such as “top”, “bottom”, “front” and “rear” here relate to the orientation of the respective component according to an operationally ready configuration of the vehicle roof on a motor vehicle.

According to a further refinement of the assembly, the tilt mechanism comprises a deployment lever, a sliding block and a sliding block guide. The deployment lever is firstly coupled pivotably to the sliding block and thereby has a first pivot axis. The deployment lever is secondly coupled pivotably to the inner cover panel and thereby has a second pivot axis. The sliding block is furthermore coupled to the cover frame by means of the sliding block guide, so that the sliding block is configured so as to be displaceable relative to the cover frame along a longitudinal axis of the vehicle roof. The tilt mechanism is configured such that the second pivot axis is positionally fixed relative to the cover, and the first pivot axis is movable on transition of the cover from the first position to the second position and is positionally fixed relative to the sliding block on reaching the second position. In particular, the drive unit is configured and arranged such that it drives the tilt mechanism directly and for example is coupled directly to the sliding block.

It has been found in connection with the present invention that motors for movable elements in or on a vehicle roof are usually fitted on the roof at the front and/or rear. For this reason, inter alia, motor supports, cable guides for mechanisms, frame parts and tubes, and in particular drive cables are required which all have a corresponding effect on the necessary installation space, the costs and mounting complexity of such a vehicle roof. In addition, such a structure leads to a reduction in headroom and causes a significant loss of visibility through a vehicle roof, in particular because of the installed motor and the cable guide of the drive cable. Also, on operation of such a movable roof element, there are actuation noises from the drive cable. Furthermore, transmission losses occur from the drive cables, which affect the force usable for movement, require seizing protection and lead to effects on a necessary motor power of the motor.

By means of the described assembly and in particular the drive unit, the disadvantageous effects described above can be countered. The assembly relates in particular to use of a tilting roof or vehicle roof with a cover which can be raised and lowered, in which the associated mechanism ensures only a deployment and retraction of the cover. Accordingly, travel paths of the drive are relatively short and the drive unit can be connected to the respective tilt mechanism and drive a drive slide directly.

Because of the described assembly, an installation space which is used in conventional designs at the front and/or rear of a vehicle roof, can remain clear. In particular, the drive unit may be arranged compactly in a side rear corner of the cover frame. A corresponding installation space directly in front of or behind the tilt mechanism is usually free, so that such a drive unit has no effect or only a slight effect on visibility through the vehicle roof.

In addition, the assembly can be actuated simply and reliably. The respective tilt mechanisms on the left and right of the vehicle roof are synchronized electronically via a respective motor actuation, instead of mechanical synchronization by means of drive cables and in some cases additional elements. Also, a bearing for the tilt or a lift mechanism may simultaneously serve as a motor housing or motor carrier of the drive unit.

The drive unit may form a separate assembly which is attached to the bearing of the tilt mechanism. For example, the motor assembly contains a spindle drive, a bearing, motor contacts, a motor housing and a coupling to the tilt mechanism via a spindle nut. Alternatively, for example, the spindle and bearing may be part of the tilt mechanism. The motor of the drive unit can be mounted and coupled via a clutch between a motor shaft and the spindle.

The described assembly allows, inter alia, the following advantages with respect to configurations of a vehicle roof:
omission of drive cables, frame parts, cable guides and guide tubes,
substantial gains in installation space and visibility, in particular in the front region of the vehicle roof relevant for visibility,
potential cost benefit,
greater design freedom for mechanical concepts, in particular with respect to a force level, movement course and interfaces,
simple cover adjustment via motor parameters instead of mechanical adjustment elements,
acoustic improvement thanks to absence of cable noises,
simple installation process.

A cover system according to the invention for a vehicle roof comprises an embodiment of the above-described assembly and a further cover which is coupled to the cover frame. Relative to a longitudinal axis of the vehicle roof, the cover of the assembly forms a front deployable roof element and the further cover forms a rear, in particular fixedly mounted, roof element for the vehicle roof. In particular, the cover system comprises two embodiments of the above-described assembly which are arranged and coupled to the roof frame mirror-symmetrically on opposite sides. Alternatively, the cover of the assembly may also form the rear cover, and the further cover may form the front cover of a two-cover system. Furthermore, alternatively, the cover system may also comprise only the cover described with the assembly and constitute a one-cover system. The cover may for example be formed so large that it extends over the entire vehicle length or over the available vehicle roof length.

A vehicle roof according to the invention for a motor vehicle comprises an embodiment of the above-described assembly, or the above-described roof system with two covers, which is coupled to a roof bodywork of the motor vehicle by means of the cover frame.

Because the cover system and vehicle roof comprise an embodiment of the assembly, features and properties of the above-described assembly are also disclosed for the cover system and the vehicle roof, and vice versa.

### BRIEF DESCRIPTIONS OF THE DRAWINGS

Exemplary embodiments of the invention are explained in more detail below with reference to the schematic drawings. The drawings show:

FIG. 1 a vehicle roof for a motor vehicle in a perspective view,

FIGS. 2-3 an exemplary embodiment of a cover system for the vehicle roof in a respective perspective view,

FIGS. 4-5 a further portion of the cover system in a respective side view,

FIG. 6 an exemplary embodiment of a cover receiving unit of the cover system in a perspective view,

FIG. 7 an exemplary embodiment of components of the cover receiving unit in a perspective view,

FIGS. 8-10 a front cover of the cover system in a respective side view,

FIG. 11 an exemplary embodiment of a cover centering unit of the cover system in a side view,

FIG. 12 the front cover with the cover centering unit in a side view,

FIG. 13 an exemplary embodiment of a tilt mechanism of the cover system in a perspective view,

FIGS. 14-17 the tilt mechanism in further views,

FIG. 18 an exemplary embodiment of a drive unit of the cover system in a perspective view,

FIGS. 19-25 the drive unit in further views,

FIG. 26 the cover system in a schematic top view,

FIG. 27 an exemplary embodiment of a sealing assembly of the cover system in a perspective view,

FIGS. 28-29 the sealing assembly in further views,

FIG. 30-38 various views and stages during production of the sealing assembly,

FIG. 39-40 exemplary embodiments of a stiffening assembly of the cover system in a respective perspective view,

FIG. 41 an illustration of relative offset positions of the cover system with respect to a vertical direction, and

FIG. 42 the cover system in a schematic top view.

Elements of the same structure or function are identified with the same reference signs across the figures. For reasons of clarity, sometimes not all elements illustrated are marked with associated reference signs in all figures.

### DETAILED DESCRIPTION

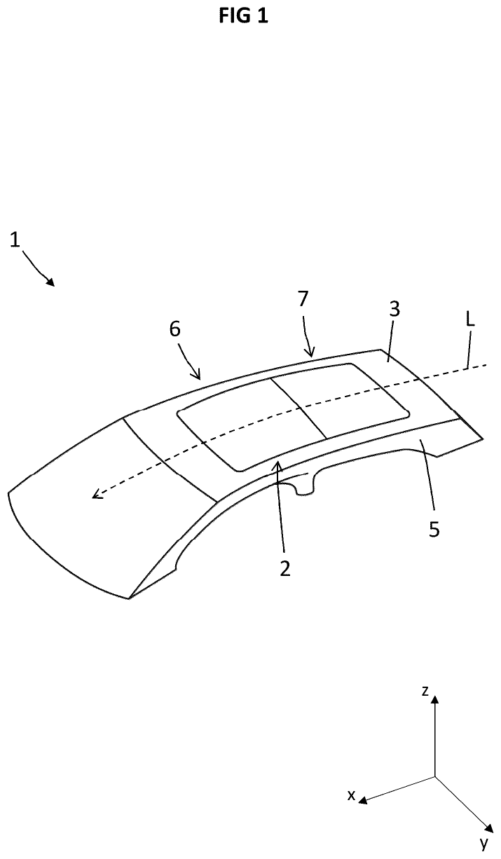

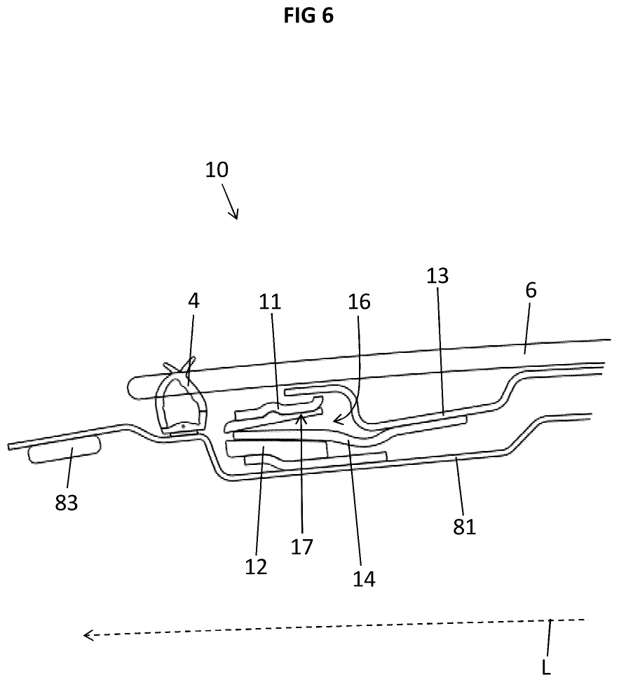

FIG. 1 shows schematically in a perspective view a vehicle roof 1 for a motor vehicle. The vehicle roof 1 comprises a cover system 2 which is coupled to a roof bodywork 5 of the motor vehicle by means of a cover frame 8. The cover frame 8 is here coupled to the roof bodywork 5 of the vehicle roof 1 by means of a cover frame support 83 (see FIGS. 6, 24 and 27). The cover frame 8 in particular also constitutes a carrier frame, e.g. for seals or mechanical components, and may be designed as one piece or multipiece. It may comprise plastic and/or steel segments and, in plan view, have a U shape, A shape, figure-of-eight shape or other shape for carrying one or more covers.

The cover system 2 comprises a first front cover 6 and a second rear cover 7 relative to a longitudinal axis L of the vehicle roof 1. The longitudinal axis L also forms a longitudinal axis of the cover system 2 and of the motor vehicle, and also represents a conventional travel direction of the operationally ready motor vehicle, along the arrow direction illustrated.

Terms such as “top”, “bottom”, “front”, “rear”, “top side”, “underside”, “front edge”, “rear edge” relate to an orientation of the respective component according to an operationally ready configuration of the vehicle roof 1 on a motor vehicle, as indicated in FIG. 1.

As will be explained with reference to the following figures, the cover system 2 allows a simple and low-cost construction of the vehicle roof 1 and also allows a particularly good visibility through the vehicle roof 1. The front cover 6 is configured as a deployable and retractable roof element, while the rear cover 7 is a fixed roof element. The front cover 6 can thus be raised or lowered at a rear edge 9 facing the rear cover 7, so that a ventilation position can be established in order to provide a ventilation function for the vehicle interior of the motor vehicle. In particular, the two covers 6 and 7 are made of glass or a transparent plastic such as acrylate glass, and allow a particularly wide view through the vehicle roof 1. Furthermore, the covers 6 and 7 may be made of or comprise polycarbonate, toughened glass or partially prestressed glass. Both a single-layer and also a two-layer or multi-layer structure of the cover 6 and/or 7 are possible.

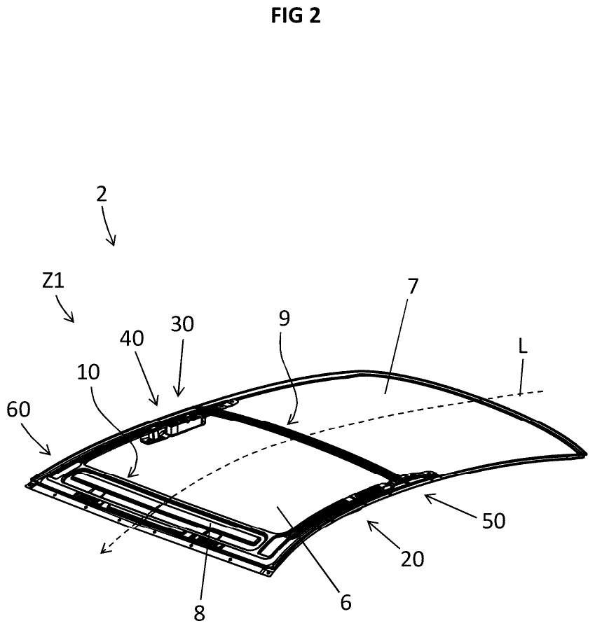

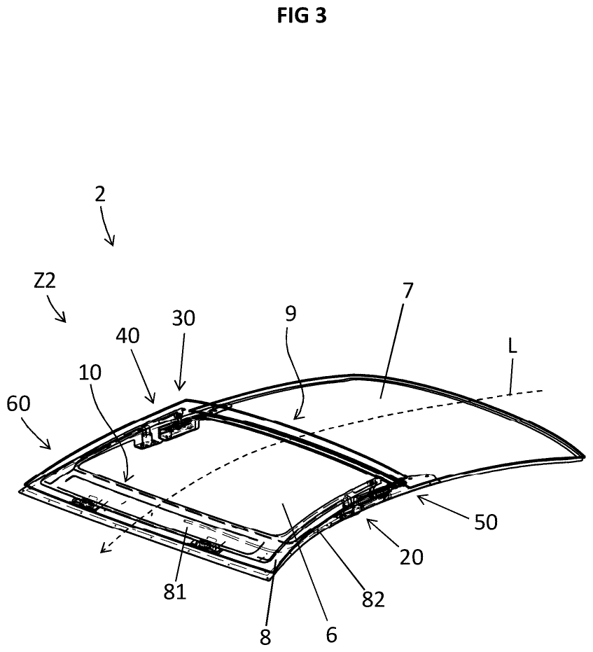

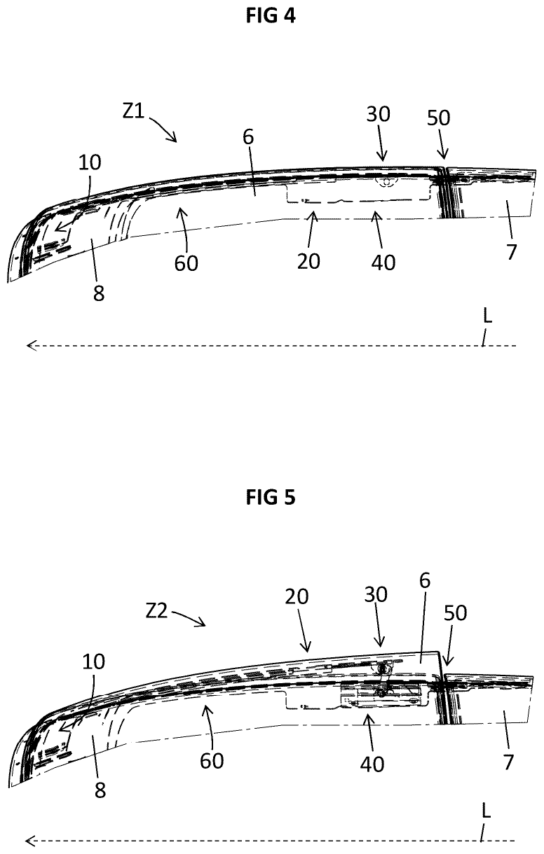

FIGS. 2 and 3 show different states of the cover system 2 in respective perspective views. FIG. 2 shows the cover system 2 in a first state or first position Z1, in which the front cover 6 is closed or retracted. FIG. 3 shows the cover system 2 in a second state or second position Z2, in which the front cover 6 is opened or deployed. FIGS. 4 and 5 show further views of the front cover 6 in a retracted and a deployed position Z1 and Z2. In each case, a side view of a front portion of the cover system 2 is illustrated.

FIG. 6 shows the cover receiving unit 10 in a perspective view from below from the vehicle interior. The cover 6 forms the deployable and retractable roof element for the vehicle roof 1. A peripheral cover seal 4 is arranged between the cover 6 and the cover frame 8. An inner cover panel 13 is coupled to an underside of the cover 6. The cover frame 8 is configured for coupling the cover 6 to the roof bodywork 5 of the motor vehicle by means of the inner cover panel 13. The cover receiving unit 10 comprises a receiving element 11 with a receiving opening 16, which is connected to the cover frame 8 at a front transverse web 81 thereof relative to the longitudinal axis L. The receiving element 11 may be coupled to the cover frame 8 by force fit, form fit and/or substance bonding. The receiving element 11 may be formed integrally with the cover frame 8.

The cover receiving unit 10 furthermore comprises a push-fit element 14 which is coupled to the inner cover panel 13. The push-fit element 14 may in particular be formed integrally with the inner cover panel 13 and be formed as a curved tab. Alternatively, the push-fit element 14 is formed as a separate component and coupled to the inner cover panel 13 by force fit, form fit and/or substance bonding. The inner cover panel 13 may also be designed as one piece or multipiece.

The push-fit element 14 and receiving opening 16 are matched to one another so that the cover 6 can be coupled to the cover frame 8 by pushing the push-fit element 13 into the receiving opening 16. In this way, a screw-free and already operationally ready state of the cover 6 can be formed at the front transverse web 81 of the cover frame 8.

The receiving element is formed U-shaped in the partial cross-section illustrated in FIG. 6, and forms an insertion pocket for the push-fit element 14. To prevent rattling, the cover receiving unit 10 comprises a vibration-damping element in the form of a plastic insert or plastic overmolding 12, which is formed in the region of the receiving opening 16 on an inside 17 of the receiving element 11. The plastic overmolding 12 has a wedge shape and, in a coupled state of the cover 6 with the cover frame 8, is arranged inside the receiving opening 16 between the receiving element 11 and the push-fit element 14, and exerts a retaining force on the push-fit element 14. The wedge shape acts as a spring and provides a degree of preload so as to counter any rattling or movement of the inserted push-fit element 14.

In particular, the plastic insert or plastic overmolding 12 may be made of a plastic such as polyoxymethylene (POM), which counters creaking in operation and also provides advantageous slip properties which may have a useful effect on a mounting process. Also, because of its softness, such a plastic may allow tolerance compensation for the components to be coupled. In addition, rib elements may also be provided on a sliding face of the plastic.

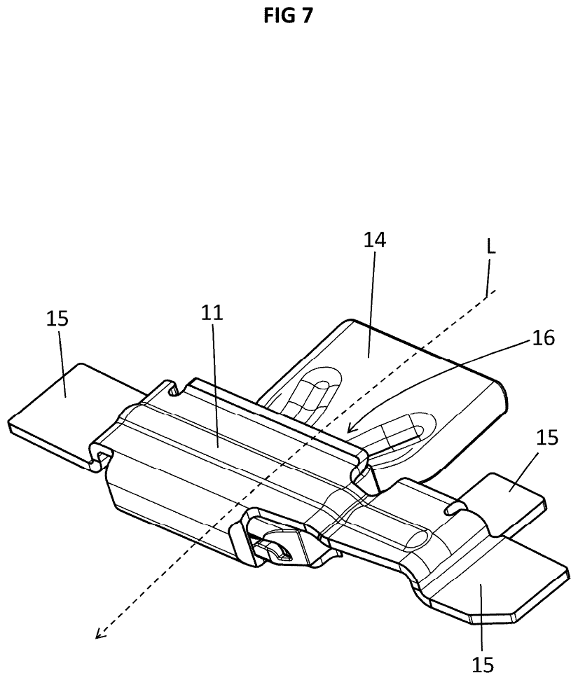

The cover receiving unit 10 may in particular comprise two or more receiving elements 11 and push-fit elements 14, which are arranged and/or configured spaced apart along the front transverse web 81 of the cover frame 8 so that, in a coupled state of the cover 6 with the cover frame 8, respective push-fit elements 14 are inserted in associated receiving elements 11. A respective receiving element 11 and push-fit element 14 may be configured as shown in FIG. 7. Connecting wings 15 may be provided for connecting the receiving element 11 to the cover frame 8. By means of the connecting wings 15, the receiving element 11 may be reliably and stably connected to the cover frame 8 by force fit, form fit and/or substance bonding, e.g. by gluing and/or welding.

In particular, by means of such an assembly and the cover receiving unit 10 in the front region of the cover frame 8, screw-free mounting of the deployable and retractable cover 6 may take place. The cover 6 can be coupled to the cover frame 8 easily and reliably because of the push-fit concept implemented via the cover receiving unit 10. Because no screws or complex bearing elements are required on a front side of the cover 6, a rotational or pivot axis of the front cover 6 may be formed relatively far at a cover front edge since no screws need be accessed for installation. The cover 6 may thus extend up to a windscreen of the motor vehicle and contribute to maximum visibility.

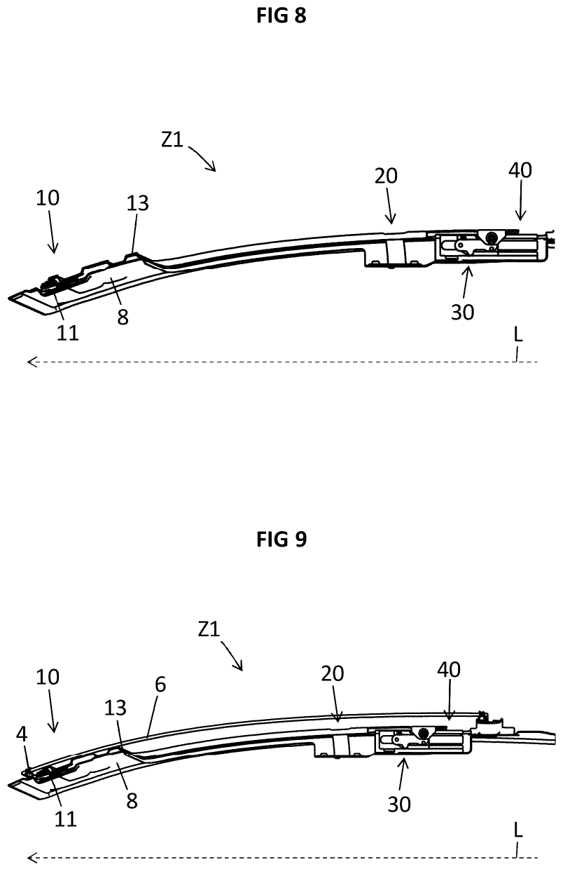

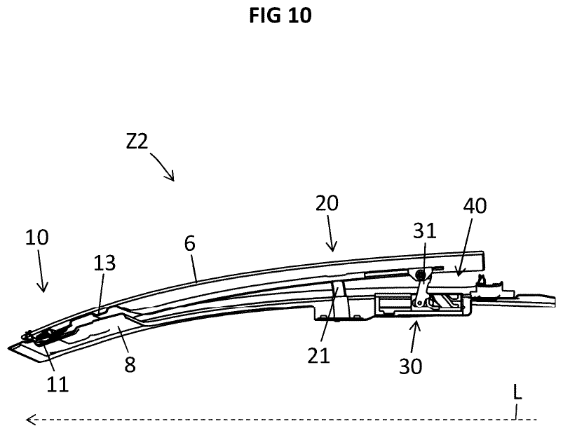

FIGS. 8 to 10 show further side views of a retracted or deployed position Z1 or Z2 of the cover 6.

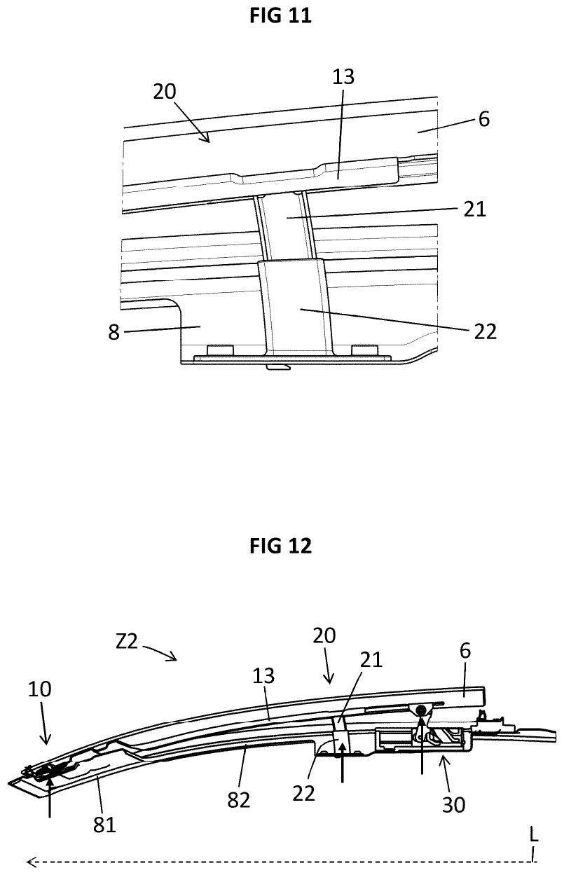

The cover system 2 furthermore comprises a cover centering unit 20 having a centering lever 21 and a lever receiver 22 which are matched to one another (see FIGS. 11-12). The lever receiver 22 is sleeve-shaped and coupled, e.g. screwed, to the cover frame 8 at a side longitudinal web 82 thereof. The centering lever 21 is coupled to the inner cover panel 13 and formed for example integrally with the inner cover panel 13, and formed as a curved tab. The cover 6 can be coupled to the cover frame 8 by means of the cover receiving unit 10, and centered relative to the cover frame 8 with respect to a main extent plane of the cover 6 by pushing the centering lever 21 into the lever receiver 22. Thus an aligned, operationally ready state of the cover 6 in the cover system 2 can be established.

A respective main extent plane of the cover 6 and cover 7, apart from existing cover curvatures, extends substantially parallel to the vehicle roof 1 and perpendicular to a vertical direction. With respect to FIG. 1, the main extent planes of the covers 6 and 7 thus lie within the X-Y plane, while the Z direction represents a vertical direction of the operationally ready motor vehicle.

The cover centering unit 20, like the cover receiving unit 10, may also comprise a vibration-damping element which is coupled to the lever receiver 22 and formed for example as a plastic overmolding on an inside of the lever receiver 22 facing the centering lever 21. In a coupled state of the cover 6 with the cover frame 8, the plastic overmolding is thus arranged between the centering lever 21 and the lever receiver 22, and contributes to a secure and low-noise retention of the cover 6.

The cover centering unit 20 is matched in particular in relation to the rotational or pivot axis of the front cover 6. This may comprise an orientation, position and/or shape of the centering lever 21 and lever receiver 22. Alternatively or additionally, the centering lever 21 and lever receiver 22 are matched to a curvature of the cover 6 with respect to their orientation, position and/or shape. The centering lever 21 and lever receiver 22 are preferably configured so as to follow a radial track segment which is predefined by the curvature, but in particular by the pivot axis of the cover 6 (see FIGS. 11-12).

A position of the cover centering unit 20 is predefined preferably depending on the load to be carried for the cover 6 and further elements cooperating with the cover centering unit 20. These include for example a tilt mechanism 30 which is coupled to the cover 6 for its deployment and retraction. In FIG. 12, the upwardly pointing arrows indicate the positions which substantially contribute to the mounting and orientation of the cover 6 according to the illustrated exemplary embodiment.

The cover centering unit 20 here forms a concept for establishing, in a simple and reliable fashion, a centering of the cover primarily in the X direction or in the direction of the longitudinal axis L. It also contributes to an orientation in the Y direction or perpendicular to the longitudinal axis L and parallel to the main extent plane of the cover 6. By means of the cover receiving unit 10, primarily a positioning in the Z direction is predefined which also defines the location of the pivot axis of the cover 6 as the starting point for mounting. Thus by means of the cover receiving unit and cover centering unit 20, a reliable and useful cover attachment concept for the deployable and retractable front cover 6 can be achieved.

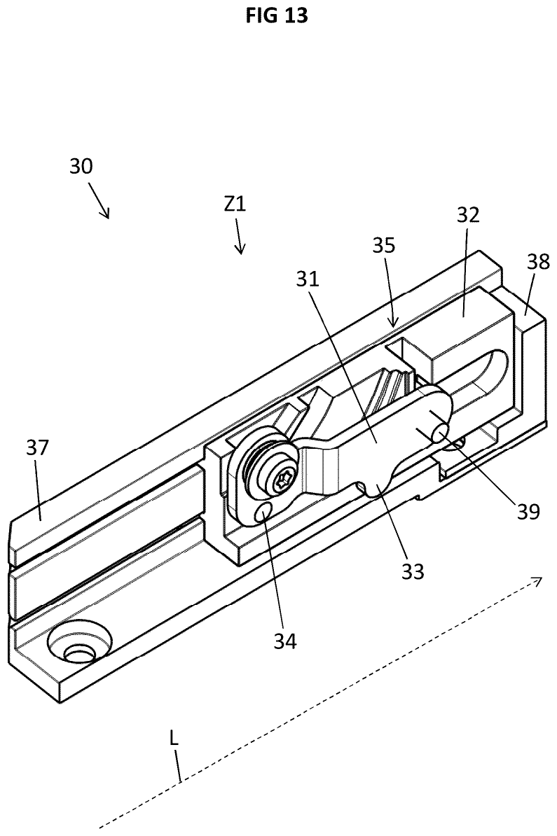

The cover system 2 furthermore comprises a tilt mechanism 30 which in particular advantageously cooperates with the cover receiving unit 10 and cover centering unit 20 (see FIG. 12). An exemplary embodiment of the tilt mechanism 30 is shown in various views in FIGS. 13-17.

The tilt mechanism 30 comprises a deployment lever 31, a sliding block 32 and a sliding block guide 37. The deployment lever 31 is coupled firstly pivotably to the sliding block 32 and thus has a first pivot axis S1.

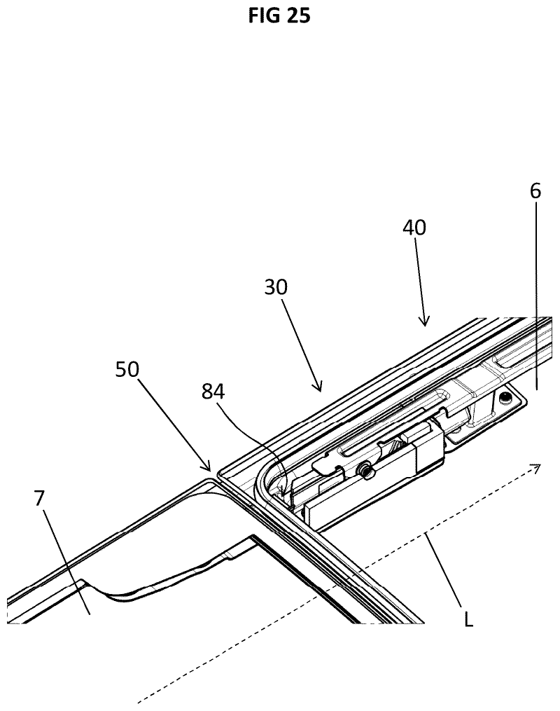

Secondly, the deployment lever 31 is coupled pivotably to the inner cover panel 13 and therefore has a second pivot axis S2. The sliding block 32 is furthermore coupled to the cover frame 8 by means of the sliding block guide 37, so that the sliding block 32 is formed movably relative to the cover frame 8 along the longitudinal axis L (see also FIG. 25).

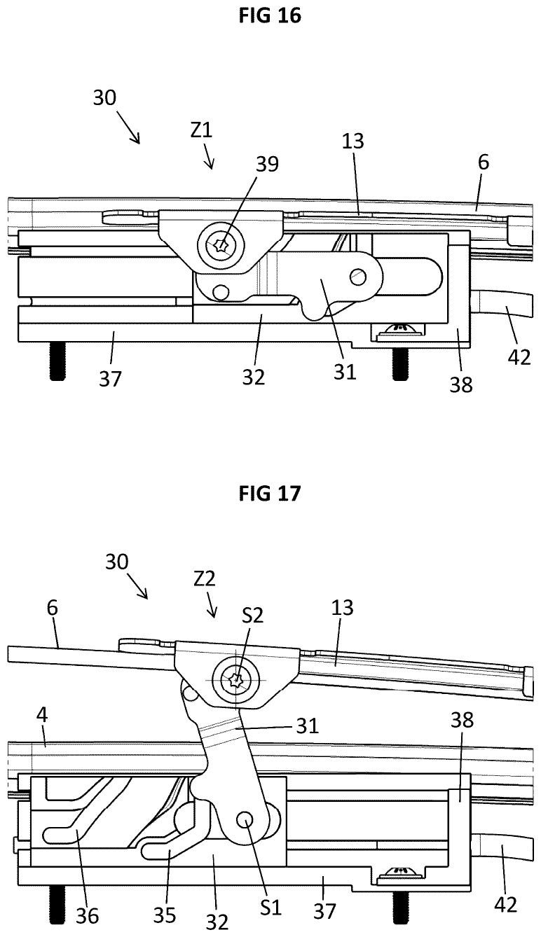

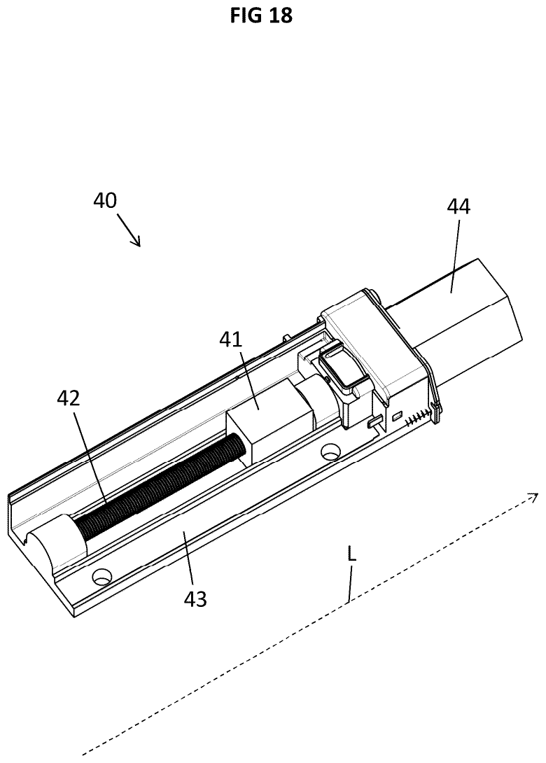

The cover 6 can be adjusted by means of the tilt mechanism 30 between the first retracted position Z1 and the second deployed position Z2. The tilt mechanism 30 is configured such that the second pivot axis S2 is positionally fixed relative to the cover 6 and the first pivot axis S1 is movable relative to the sliding block 32 on transition of the cover 6 from the first position Z1 to the second position Z2, and positionally fixed relative to the sliding block 32 on reaching the second position Z2 (see FIGS. 16 and 17).

The deployment lever 31 has a first, a second and a third coupling peg 33, 34 and 39. The sliding block 32 has a first and a second slotted track 35 and 36 in which the respective coupling pegs 33 and 34 engage. The first coupling peg 33 is thus accordingly mounted guidably in the first slotted track 35, and the second coupling peg 34 is accordingly mounted guidably in the second slotted track 36, so that the transfer of the cover 6 from the first position Z1 to the second position Z2 and back is track-guided.

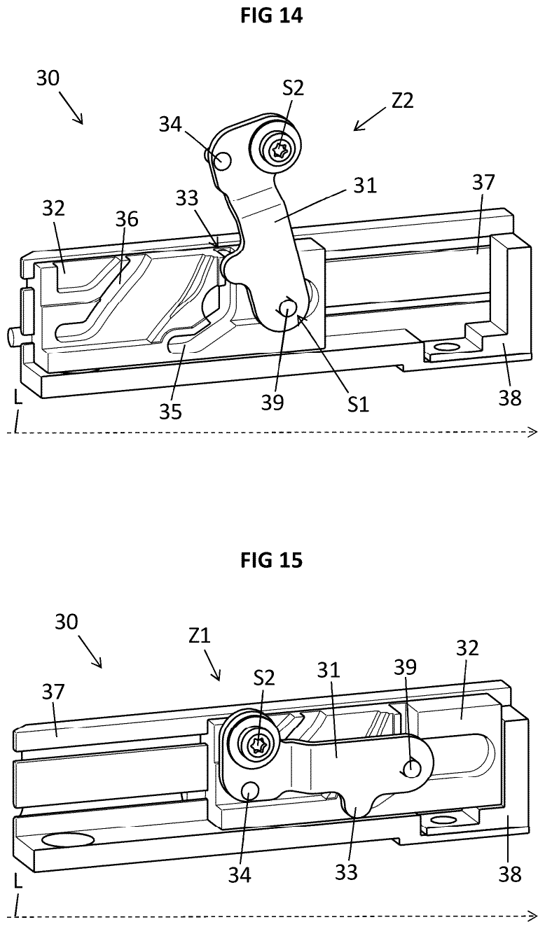

In particular, the second slotted track 36 is formed open at the top so that the second coupling peg 34 can be decoupled from the second slotted track 36 when the deployment lever 31 is actuated and the second position Z2 is assumed. The first coupling peg 33 remains coupled in the first slotted track 35. When the deployment lever 31 is retracted and the first position Z1 assumed, the second coupling peg 34 re-engages into the second slotted track 36 (see FIGS. 14 and 15). Relative to a vertical direction perpendicular to a main extent plane of the cover 6, the second coupling peg 34 is thus arranged above the first coupling peg 33 on transfer of the cover 6 from the first position Z1 to the second position Z2.

On a side of the deployment lever 31 opposite the first and second coupling pegs 33 and 34, the third coupling peg 39 extends into a slotted track 371 of the sliding block guide 37. The third coupling peg 39 is accordingly mounted guidably in the slotted track 371 of the sliding block guide 37. The slotted track 371 of the sliding block guide 37 is delimited in predefined fashion on both sides relative to the longitudinal axis L, and establishes a respective end stop for the third coupling peg 39 for forming the first and second positions Z1, Z2 of the cover 6. Also, the third coupling peg 39 forms the first pivot axis S1 of the deployment lever 31.

The tilt mechanism 30 furthermore comprises one or more stop elements, or cooperates with adjacent components which serve as stop elements, to provide a predefinedly limited travel path. The sliding block 32 can be moved along the sliding block guide 37 between a first and a second stop element. The tilt mechanism 30 is preferably arranged at the rear corner of the cover frame 8, so that the first stop element 84 is formed by a portion of the cover frame 8 (see FIG. 25). The second stop element is formed by a slide stop 38 which lies opposite the first stop element relative to the slotted track 371 of the sliding block guide 37.

In this context, it is pointed out that terms such as “top”, “bottom”, “front”, “rear”, “top side”, “underside”, “front edge”, “rear edge” refer to an operationally ready orientation of the respective components, according to the illustration of the vehicle roof 1 shown in FIG. 1. Accordingly, the cover frame 8 has two rear corners which lie opposite one another relative to the longitudinal axis L. If the longitudinal axis L forms a symmetrical center axis of the vehicle roof 1, the described components of the tilt mechanism are preferably also formed and arranged in mirror image on the other side of the vehicle roof 1. The same applies to the components of the cover centering unit 20 and cover receiving unit 10, and components described below of the cover system 2 which preferably contribute to a symmetrical structure relative to the longitudinal axis L.

The slotted track 371 is for example formed closed on one side and, alternatively or additionally to a rear corner of the cover frame 8, forms an end stop for the travel path of the deployment lever 31. The slide stop 38 is for example configured such that a protruding region thereof engages in an open end of the slotted track 371 of the sliding block guide 37, and delimits this in predefined fashion on one side (see FIGS. 15 and 17).

The described tilt mechanism 30 has a clear and compact structure which can also be produced very economically with a low number of components. In particular, the tilt mechanism 30 allows a deployment and retraction of the front cover 6 without requiring a long guide rail, which would normally extend on each side along almost the entire longitudinal web 82 of the cover frame 8. In addition, by use of the tilt mechanism 30, no additional cover carrier is required as a tolerance compensation element, because the rotational point or first pivot axis S1 of the tilt mechanism 30 is arranged at the connection between the mechanism and the cover 6. A corresponding compensation takes place cost-neutrally in a bearing mount of the sliding block 32 or sliding block guide 37.

In this way, a particularly compact construction of the tilt mechanism 30 can be achieved, which advantageously also allows maximum visibility through the cover 6 and vehicle roof 1. This may furthermore be achieved in that the tilt mechanism 30 is in particular matched to a drive unit 40 of the cover system 2, by means of which the sliding block 32 can be coupled so as to be directly drivable.

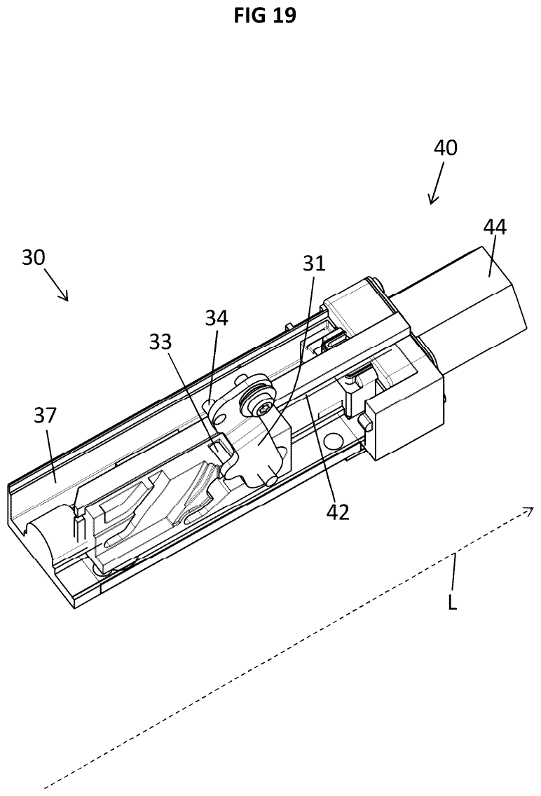

The cover system 2 furthermore comprises the drive unit 40 which, in particular, advantageously cooperates with the tilt mechanism 30. FIG. 18 shows an exemplary embodiment of the drive unit 40 in a perspective view. FIGS. 19-25 show further embodiments and/or views of the drive unit 40.

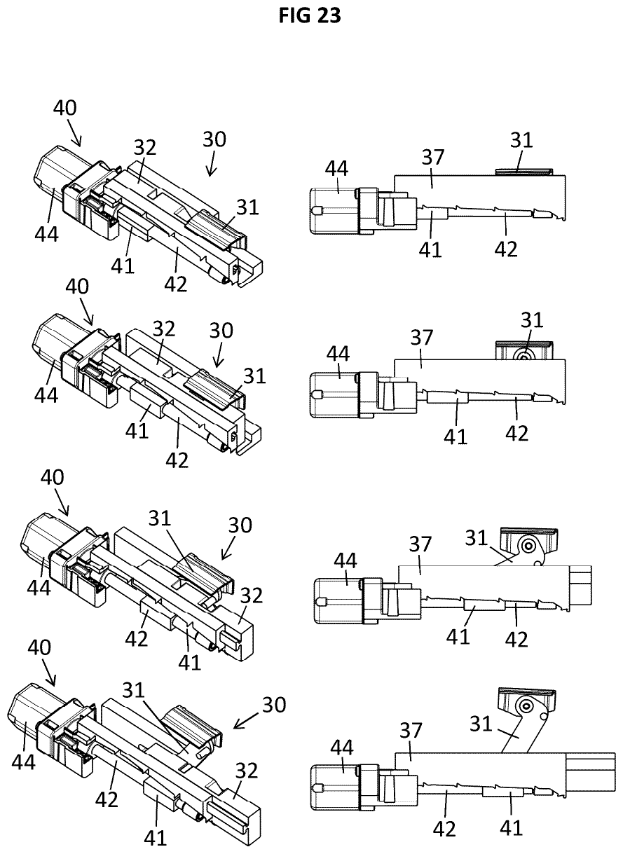

The drive unit 40 is an electric drive which is configured to drive the tilt mechanism 30 directly, in particular without drive cable. The cover 6 can therefore be adjusted electrically between the first and second positions Z1, Z2 by means of the drive unit 40 and the tilt mechanism 30, without the use of a drive cable. According to the illustrated exemplary embodiments, the drive unit 40 is formed as a spindle drive with a motor 44 and a driving spindle 42, by means of which the drive unit 40 is directly coupled to the tilt mechanism 30. This can be achieved by a drive coupling element 41 which, for example in the form of a spindle nut, drives the sliding block 32 and causes a deployment and retraction of the deployment lever 31 of the tilt mechanism 30 (see FIGS. 19 and 23).

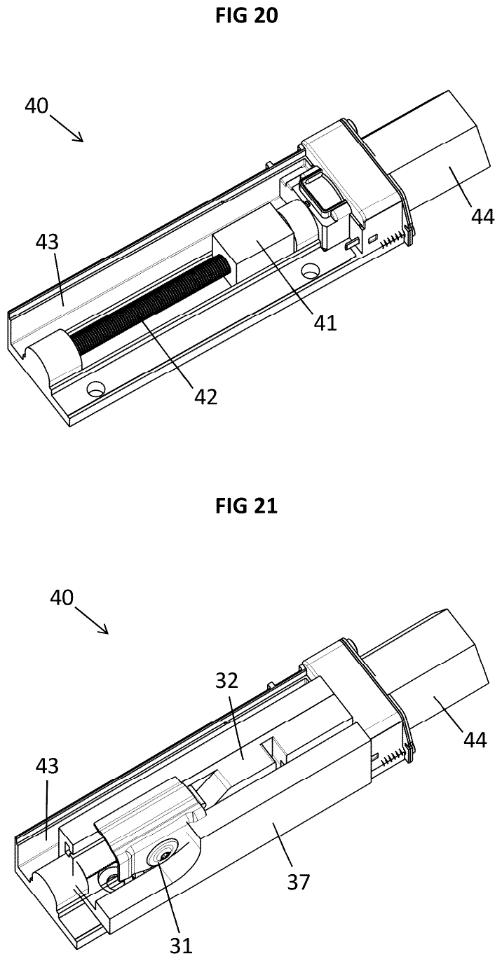

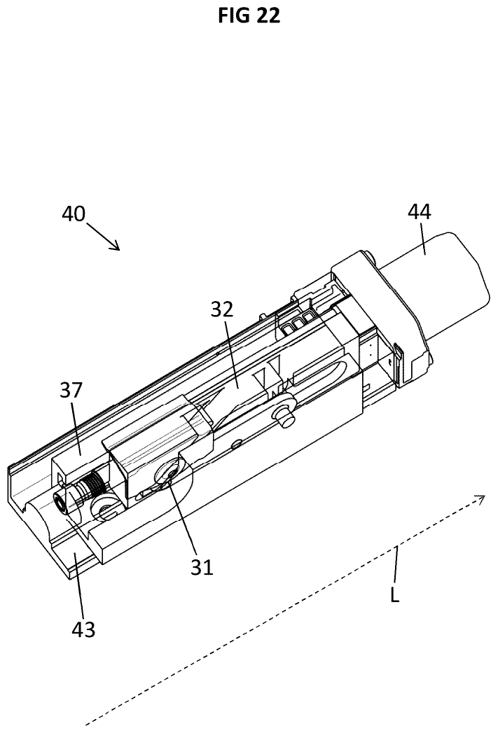

The tilt mechanism 30 may be mounted, matched to the drive unit 40, in a common holder 43 of the drive unit 40 as illustrated in FIGS. 20 and 21. Alternatively, the drive unit 40 may form a separate assembly which is coupled to the sliding block guide 37 of the tilt mechanism 30 (see FIG. 19). In particular, the tilt mechanism 30 and the drive unit 40 may be integrated so that they share components. The drive element 41 and the sliding block guide 37—which for example, in addition to guiding the sliding block 32, may also serve as a bearing for the drive unit 40—form for example parts of the tilt mechanism 30 and of the drive unit 40 (see FIGS. 22 and 23). Thus a particularly compact construction of the tilt mechanism 30 and drive unit 40 can be achieved, which contributes to greater visibility through the vehicle roof 1 and also provides an easily controllable ventilation function.

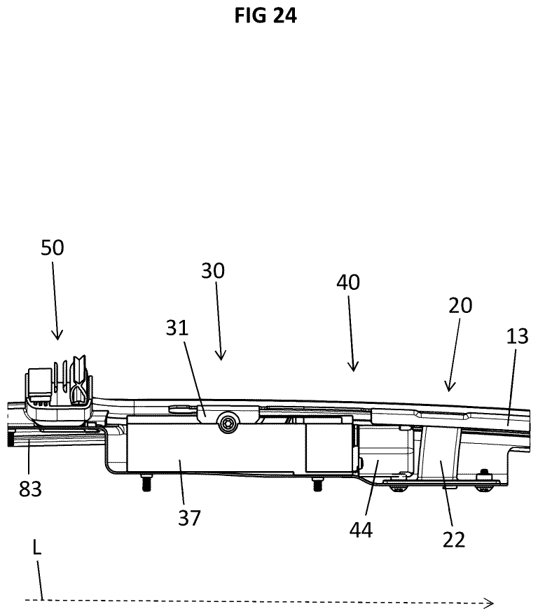

Preferably, as illustrated in FIGS. 24-26, a drive unit is coupled to the cover frame 8 and an associated tilt mechanism 30 at a respective side longitudinal web 82 of said cover frame 8. The drive unit 40 is here installed in the respective rear corner of the cover frame 8, so that the motor 44 of the respective drive unit 40 faces the front of the vehicle roof 1 or of the motor vehicle. The cover system 2 therefore comprises a dual motor concept, as illustrated for example in FIGS. 2, 3 and 26. In particular if the tilt mechanism 30 and the drive unit 40 only perform the deployment and retraction of the front cover 6, travel paths of the drive unit can be kept very short. The motor 44 may therefore be attached directly to the respective tilt mechanism 30 and drive the sliding block 32 directly.

Thus an installation space in the vehicle roof 1 at the front or rear can be kept clear and used for wider visibility, in comparison with conventional concepts which comprise long guide rails and drive cables. The installation space directly in front of or behind a deployment mechanism is often free, so that this position can usefully be used for arranging the motor 44 of the drive unit 40 and does not reduce or only slightly reduces visibility through the vehicle roof 1.

Advantageously, the tilt mechanisms 30 installed on the right and left, or on opposite sides of the vehicle roof 1, can advantageously be synchronized electronically via a motor actuation of the respective drive 40. Thus complex mechanical synchronization via drive cables may be omitted. Also, a bearing or holder of the tilt mechanism 30 may simultaneously constitute a motor housing or a motor carrier of the drive unit 40. The drive unit 40 may furthermore comprise a gear mechanism and/or a clutch which is arranged between the spindle 42 and a shaft of the motor 44.

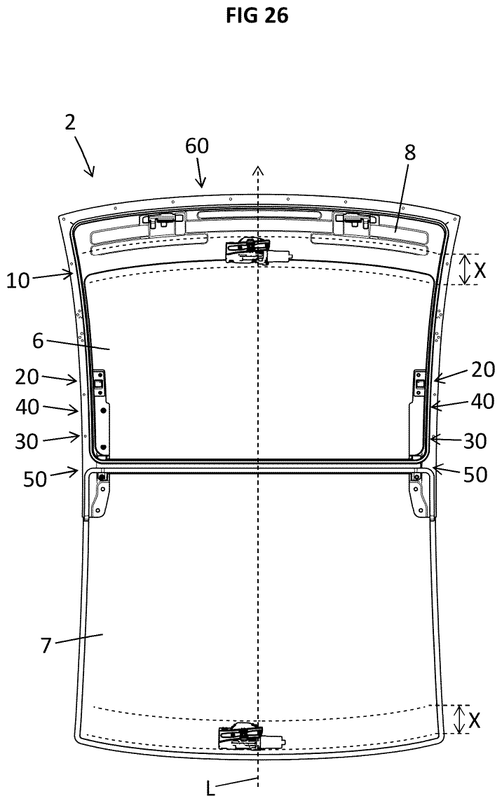

In particular in connection with the above-described tilt mechanism 30, the drive unit 40 allows an omission of drive cables, frame parts and cable guides or guide tubes. Accordingly, a substantial saving can be made in installation space, in particular in the frontal region of the vehicle roof 1 which is particularly relevant for visibility. Such an installation space and gain in visibility are indicated in FIG. 26 by region X which, with a conventional actuation and deployment concept of a cover, is arranged at the front and/or rear of a vehicle roof.

The drive unit 40 and tilt mechanism 30 furthermore allow a cost saving because of the low number of components, and provide greater design freedom for mechanical concepts. Also, a reliable cover adjustment of the front cover 6 can take place by a simple setting of motor parameters of the respective drive unit 40, instead of requiring mechanical adjustment elements. In addition, the drive unit 40 and tilt mechanism 30 can contribute to simpler installation and better acoustics of the cover system 2 because of the absence of drive cables and corresponding cable noise.

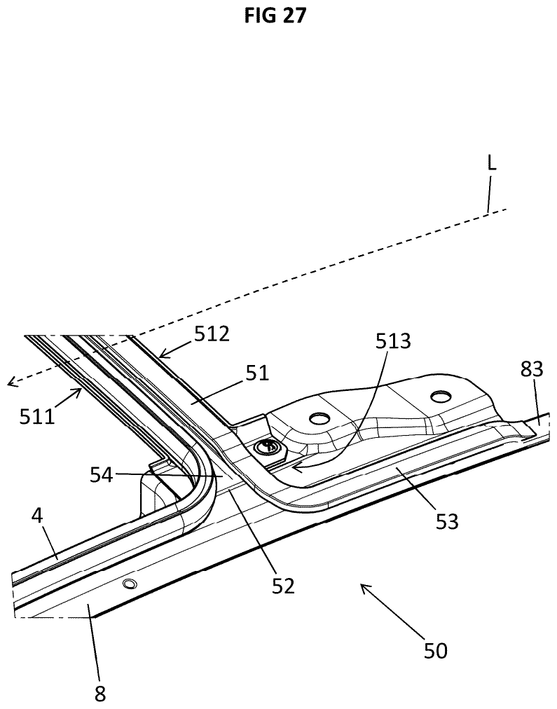

The cover system 2 furthermore comprises a sealing assembly 50 which reliably seals an intermediate space between the rear edge 9 of the front cover 6 and a front edge 71 of the rear cover 7 (see FIGS. 27-29). The cover seal 4, together with an adhesive track 53 and a transverse web 51, forms a channel which establishes a water gully 54 for discharge of water.

The adhesive track 53 is configured to couple the second cover 7 to the cover frame 8 and the transverse web 51. The transverse web 51 is coupled, for example screwed and/or bonded, to the cover frame 8 on opposite sides relative to the longitudinal axis L. The cover frame 8 is preferably U-shaped. The transverse web 51 connects the side longitudinal webs 82 of the cover frame 8. Optionally, the cover frame 8 may, in addition to the front transverse web 81, also have a rear transverse web which may contribute to a particularly stable cover frame 8.

The sealing assembly 50 also comprises a permanently plastic sealing element 52 on each vehicle roof side, which is made in particular as a butyl strip and applied in predefined fashion. The cover seal 4 is coupled to a transverse web 51 at a front side 511 thereof. The adhesive track 53 is coupled to the transverse web 51 at a rear side 512 thereof. Thus the cover seal 4, the adhesive track 53 and the transverse web 51 form the water gully 54. The cover seal 4 and the adhesive track 53 are furthermore each coupled to the cover frame 8 at opposite edge regions 513 of the transverse web 51. The respective sealing element 52 is arranged in the associated edge region 513 of the transverse web 51 and tightly coupled thereto and to the cover frame 8, the cover seal 4 and the adhesive track 53. Thus the sealing element 52 reliably seals an intermediate space between the transverse web 51, the cover frame 8, the cover seal 4 and the adhesive track 53 against undesired water ingress.

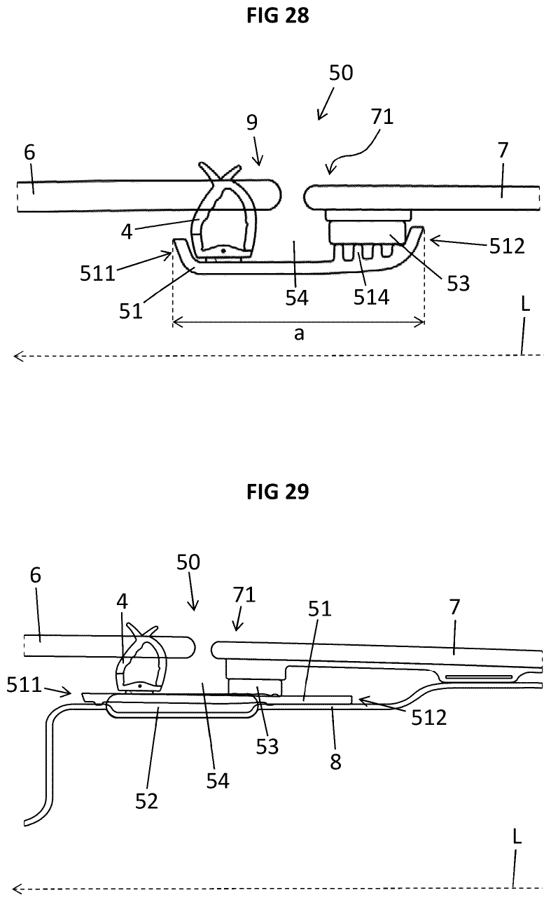

According to the exemplary embodiment in FIG. 28, on a top side, the transverse web 51 may have a plurality of coupling ribs 514 which extend into the adhesive track 53 and contribute to a reliable coupling of the rear cover 7 with the transverse web 51. The peripheral cover seal 4 for the front cover 6 may also be connected, in particular glued, to the transverse web 51 at a top side thereof. FIG. 29 shows a further possible design of the sealing assembly 50.

In particular, the transverse web 51 is made of plastic or comprises plastic, and forms a component for the vehicle roof 1 which is visible from a vehicle interior of the motor vehicle. In particular, the transverse web 51 may also be configured as a material composition of glass-fiber-reinforced tapes. The transverse web 51 is particularly slender so as to conceal the transition between the covers 6 and 7, and also ensure a correspondingly attractive aspect and contribute to increased comfort of the vehicle interior. According to the illustration in FIG. 28, in the direction of the longitudinal axis L, the transverse web 51 has a dimension a of only 40 mm, 45 mm or 50 mm for example. Thus a particularly neatly concealed cover transition, and also a reliably sealed water discharge can be achieved by means of sealing assembly 50. This thereby allows particularly good visibility through the vehicle roof 1 or the covers 6 and 7.

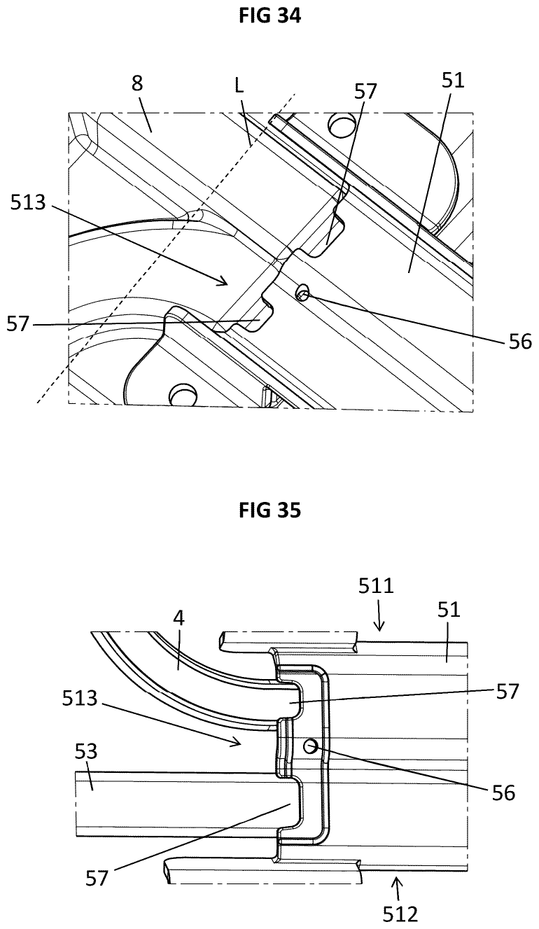

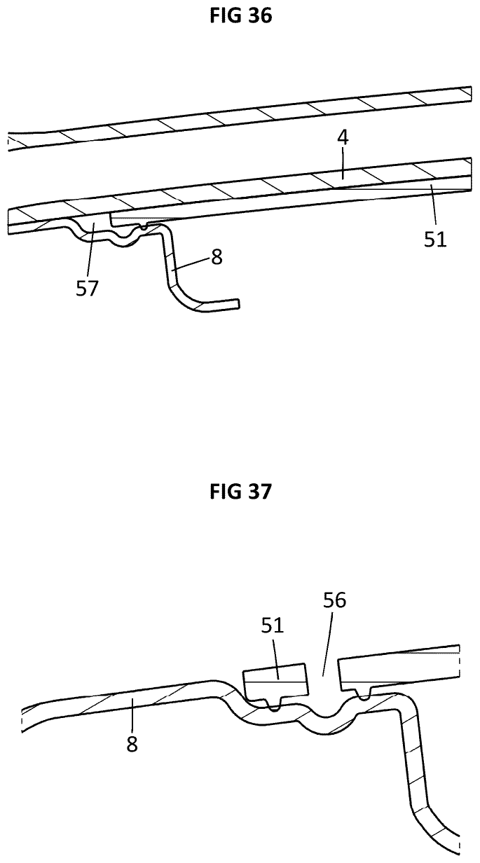

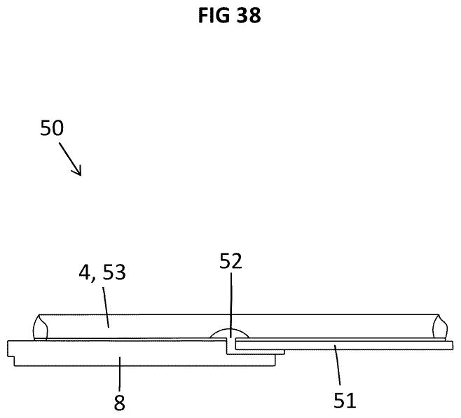

To form the sealing assembly 50, at predefined positions, the transverse web 51 may have one or more injection channels 56 and monitoring openings or outlet openings 57, via which the sealant for forming the sealing element 52 is injected and applied (see FIGS. 34-37).

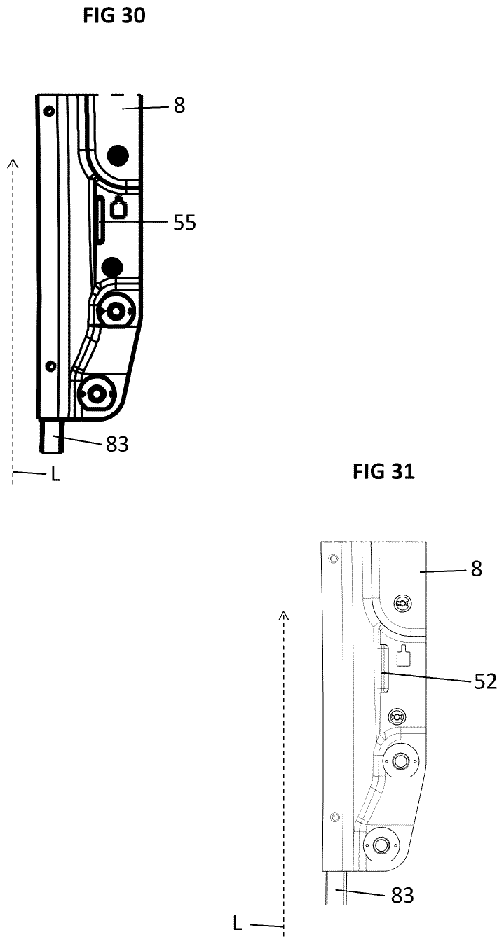

FIGS. 30-33 show various stages of a possible production method for forming the sealing assembly 50. In one step, the above-described components such as the cover frame 8, cover seal 4, adhesive track 53 and transverse web 51 are provided. The cover frame 8 may be provided with a recess forming a sealant receiver 55, in which the sealant is applied and the sealing element 52 formed (see FIGS. 30 and 31). This may comprise in particular injection or application of the sealing material in the form of hot butyl and the formation of a butyl strip, which constitutes a preferred embodiment of the sealing element 52.

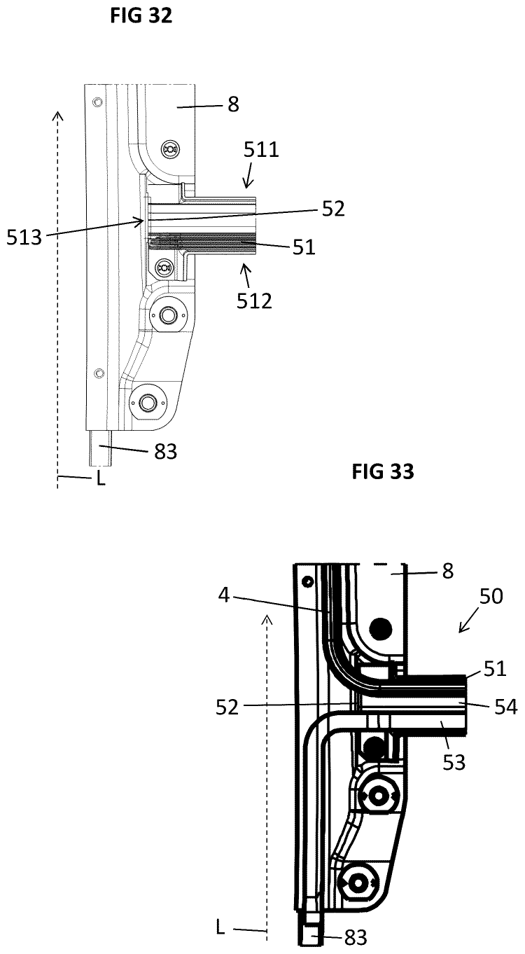

In a further step, the transverse web 51 is mechanically coupled to the cover frame 8 and pressed into the applied butyl strip (see FIG. 32). In order to guarantee adequate impression and reliable sealing, the butyl strip is preferably formed with a defined protrusion into which the transverse web 51 and further components can be pressed.

In a further step, the cover seal 4 and/or the adhesive track 53 is coupled, in particular glued, to the transverse web 51 and the cover frame 8 and pressed into the applied butyl strip (see FIG. 33).

In particular, components are pressed into the butyl strip with the sealant in a warmed or soft state, so that a useful shape adaptation to the impressed components can be achieved. If the butyl strip is applied before the transverse web 51, this is pressed into the butyl strip so that a defined material surplus emerges at the respective joining points. The cover seal 4 is pressed into such a bead so as to create a sealed connection with no or few capillaries. The adhesive track 53 is also guided via such a bead and for example pressed tightly into the bead when the rear cover 7 is placed in position.

The sealing assembly 50 may alternatively be produced in a different order or different fashion. For example, the transverse web 51 is coupled to the cover frame 8 on opposite sides relative to the longitudinal axis L and forms a respective cavity, forming a sealant receiver between the transverse web 51 and the cover frame 8. Then the cover seal 4 may be arranged on the front side 511 of the transverse web 51 and the cover seal 4 coupled to the cover frame 8 at the respective edge region 513 of the transverse web 51.

The adhesive track 53 is applied to the transverse web 51 at the rear side 512. This may be carried out with or without the rear cover 7, so that the rear cover 7 is connected to the adhesive track 53 before or afterwards. The adhesive track 53 is applied to the cover frame 8 at the respective edge region 513 of the transverse web 51, so that the cover seal 4, the adhesive track 53 and the transverse web 51 establish the predefined channel which forms the water gully 54 for discharge of water.

Now the permanently plastic sealant may be injected into the respective cavity and the sealing element 52 formed. This may take place in particular by means of the injection channel(s) 56 and monitoring or outlet openings 57. It is preferably checked that joining points between the transverse web 51 and the cover frame 8, cover seal 4 and/or adhesive track 53 have been completely coated with butyl or sealant.

The cover seal 4 and/or the adhesive track 53 may thus be coupled to the transverse web 51 and the cover frame 8 before or after injection or application of the sealant.

The described sealing assembly 50 allows the installation space required for the water gully 54 between the covers 6 and 7 to be kept very small. In comparison with conventional concepts, the cover frame 8 with transverse web 51 is made of multiple pieces, wherein the transverse web 51 is mechanically connected to the cover frame 8, and as a plastic component 51 also constitutes an aesthetic aspect in the interior design of the vehicle interior.

The peripheral cover seal 4 of the front cover 6 and the adhesive track 53 of the rear cover 7 run via the transverse web 53 and together form the water gully 54, which serves for drainage in a wet region of the cover frame 8. The permanently plastic sealant, in particular in the form of a butyl strip, here makes no or only little contribution to the strength of the mechanical connection.

The sealing assembly 50 can be produced at low cost even in small quantities. It is flexibly adaptable and also provides a robust and reliable sealing structure. The sealing assembly 50 is in particular suitable for deployable and retractable covers such as the front cover 6, which may be made relatively soft. A joining point between the cover 6 and transverse web 51 is therefore preferably designed to be highly flexible so as to contribute to a long service life of a reliable seal. Furthermore, by means of the sealing assembly 50, the use of separating foils or finishing work, as normally required for polyurethane foam overmoldings, can be saved. Accordingly, the sealing assembly 50 can be produced in a relatively simple and time-saving process.

The cover system 2 is also predefined with respect to an overall stiffness of cooperating components. In this respect, the deployable and retractable front cover 6 has a predefined stiffness A, and the fixedly installed rear cover 7 has a predefined stiffness B. The stiffnesses A and B may each relate to the entire cover 6 or 7 or to local portions of the two covers 6 or 7. In particular, the mutually facing cover edges, i.e. the rear edge 9 of the front cover 6 and the front edge 71 of the rear cover 7, are formed with predefined and mutually matched stiffnesses A and B. The transverse web 51 also has a predefined stiffness C. The stiffnesses A, B and C may each relate to the overall stiffness of the associated component, or to portions of these components which are formed with the corresponding stiffness in targeted fashion.

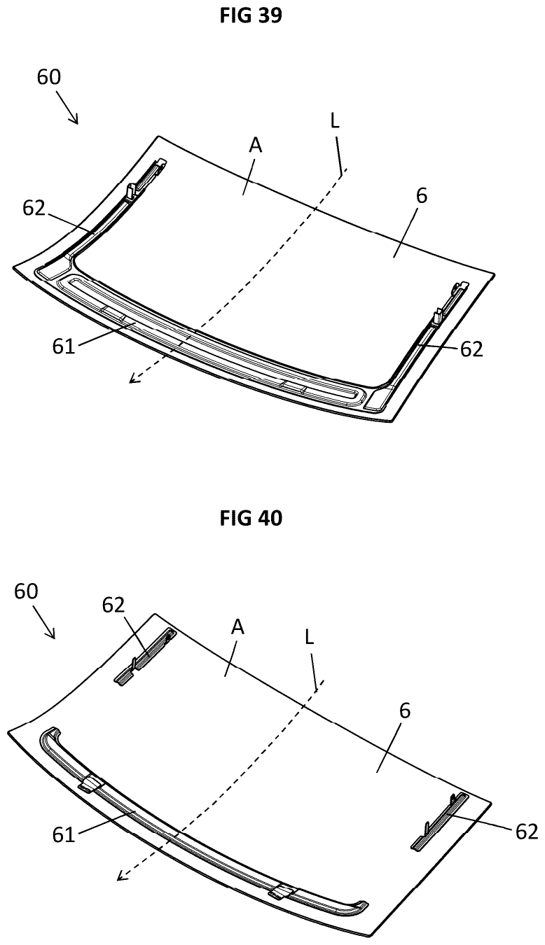

In addition, the cover system 2 comprises a stiffening assembly 60 which consists of a U-shaped stiffening frame with a front transverse web 61 and two side longitudinal webs 62. The stiffening frame 61, 62 may be cohesive, in particular as one piece, or be made of multiple spaced portions as illustrated in the exemplary embodiments in FIGS. 39 and 40.

The stiffening frame 61, 62 is arranged in predefined fashion on an underside of the front cover 6 so as to form the stiffness A of the front cover 6 or contribute to this in predefined fashion. The stiffening frame 61, 62 preferably forms the inner cover panel 13 shown in FIGS. 6, 11, 12, 16, 17 and 24. In other words, the inner cover panel 13 is configured so that, in addition to the above-described functions, it also constitutes the stiffening frame 61, 62. Alternatively, the stiffening frame 61, 62 may form an additional reinforcement of the inner cover panel 13 and contribute to a particularly stable cover system 2.

The stiffening frame 61, 62 and the stiffnesses A, B, C of the two covers 6, 7 and the transverse web 51 are matched to one another such that an upward movement of the covers 6, 7, in the direction of a vertical to a respective main extent plane of the front and/or rear cover 6, 7, is deliberately allowed within a predefined tolerance range.

Such a tolerance range may for example comprise a movement of the front cover 6 of up to 10 mm and a movement of the rear cover 7 of up to 5 mm. For example, the stiffnesses A, B and C are configured such that in the cooperation of the components, movements of the front and/or rear cover 6, 7 by 12 mm, 14 mm, 16 mm, 18 mm, mm or up to 30 mm, 40 mm or 50 mm can be tolerated.

Alternatively, the tolerance range may relate to a relative movement of the covers 6 and 7, so that an overall stiffness of the cover system 2 is achieved which has the effect of allowing a distance of for example mm or 12 mm or 15 mm between a mutually facing lower edge of the front cover 6 and a lower edge of the rear cover 7.

The permitted and desirably tolerated, possible upward movements of the covers 6 and/or 7 during travel of the motor vehicle, and the associated reduced pressure caused by the travel wind which lifts the covers 6 and 7 upward, are predefined with respect to an overall sealed cover system 2.

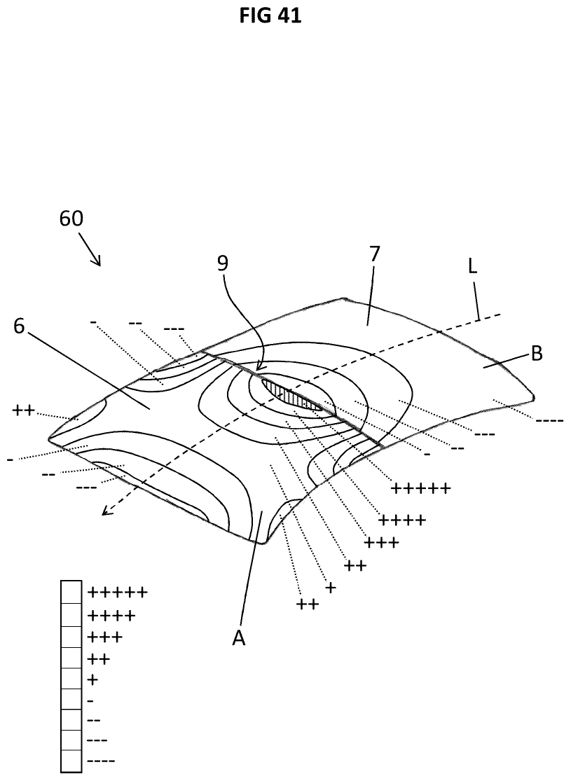

In the context of the present invention, it has been found that during travel of the motor vehicle, locally different suction forces apply to the covers 6 and 7 and pull these upward. Accordingly, the upward movements of cover portions of the covers 6 and 7 have different extents. FIG. 41 illustrates the locally dependent wind load which acts on the covers 6 and 7 with predefined geometries and properties during travel of the motor vehicle at a speed of 250 km/h. From this diagram, it is clear that the acting wind load causes significantly greater upward movements at the front deployable and retractable cover 6 than at the rear fixed cover 7. The respective upward movements may also be described as Z shifts or a Z offset according to the coordinate system shown in FIG. 1.

FIG. 41 shows that the Z offset is greatest at the rear edge 9 of the front cover 6. At this position, the front cover 6 has a Z offset of over 8 mm for example. At a front side and at the sides of the rear corners of the front cover 6, the Z offset is substantially smaller, e.g. 0.5 mm to 3 mm. The majority of the front cover 6 between the above-described positions has a Z offset of e.g. 3 mm to 6 mm.

The majority of the rear cover 7 experiences no significant upward shift. In a front central region, there is an upward Z offset of the rear cover 7 of e.g. 0.5 mm or more. The rear cover 7 has the largest Z offset of e.g. more than 3 mm at its front edge 71.

Based on such knowledge, the stiffness of the cover system 2 is set in targeted fashion such that, despite such movements, a safe, reliable and sealed roof system for the vehicle roof 1 is achieved. In matching the stiffnesses A, B and C to one another, it is also taken into account that conventional cover stiffening components cause a considerable loss of visibility through a vehicle roof. This is caused for example by profile geometries, foam overmoldings and by a nesting with mechanical concepts. In particular, the joint between two covers in a vehicle roof normally has visually relatively bulky appearance and constitutes an undesired interruption in the glass surface of a corresponding vehicle roof. In addition, such components reduce headroom because of the profile height. By means of a suitably predefined stiffness concept, such as that of the described cover system 2, these undesired influences can be countered.

By means of the above-described cover receiving unit 10 and tilt mechanism 30, the rotational point or pivot axis at the front and the deployment mechanism at the rear are separated from one another on the front cover 6, and coupled together only via the cover reinforcement or inner cover panel 13 and/or the stiffening frame 61, 62. In order to contribute to a particularly good visibility through the vehicle roof 1 and take account of possible cover movements, only local reinforcing elements are arranged on the front cover 6 in the form of a U-shaped stiffening frame 61, 62, which in particular is already implemented by the inner cover panel 13.

The rear edge 9 of the front cover 6 is for example deliberately made softer than in normal configurations and has no additional reinforcing elements. The front cover 6 is thus free from reinforcement at its rear edge 9. The front edge 71 of the rear cover 7 is for example also deliberately made soft and coupled to the transverse web 51 via the adhesive track 53, which forms part of the water gully 54 and is used as a sealant carrier and, in comparison with stiffnesses A and B of the two covers 6 and 7, makes no significant contribution to stiffness. Thus a minimal loss of visibility in the region of the cover joint between the covers 6 and 7 can be achieved.

The transverse web 51 is preferably designed as a plastic part with predefined stiffness C. The transverse web 51 may also form a mechanically load-bearing support below the front cover 6, or be designed sufficiently soft that it yields (locally) under the sealing pressure acting when the cover 6 is retracted into position Z1. The transverse web 51 may also have a further element which comprises a further support below the front cover 6 at the front edge 71 of the second cover 7, and is designed to limit a vertical movement of the second cover 7 and adapt to the first cover 6.

Because of the design of the transverse web 51 with stiffness C, and the use of stiffenings in one or both cover edges 9, 71, and in particular by the targeted design of stiffnesses A and B in the region of the cover edges 9 and 71, an overall stiffness in the region of the joining point between the covers 6 and 7 can be managed. Here, further parameters such as respective material, metal insert, glass thickness and glass type, attachment to mechanisms and bodywork, adhesive, PU foam overmolding etc., may be taken into account in order to have additional degrees of freedom for design or influencing of the stiffnesses A, B and/or C. In particular, the transverse web 51 may comprise tapes as inserts, and/or be configured as or comprise an organic composition of tapes and/or an organic sheet. An organic sheet contains for example carbon fibers embedded in a plastic matrix.

The stiffnesses A and B of the two covers 6 and 7 are globally matched to one another and set such that unacceptable relative movements of the covers 6, 7, such as may occur for example because of wind load, are avoided or at least countered. In particular, the following configurations of the stiffnesses A and B of the covers 6 and 7 may contribute to a stable and secure cover system 2 with reliable function of the covers 6, 7:

1. Stiffnesses A and B are equal:
Curvatures of the rear edge 9 of the front cover 6 and of the front edge 71 of the rear cover 7 are nominal;

2. Stiffness A is greater than stiffness B:
Curvatures of the rear edge 9 of the front cover 6 and of the front edge 71 of the rear cover 7 are nominal;

3. Stiffness A is greater than stiffness B:
Curvature of the rear edge 9 of the front cover 6 is nominal and curvature of the front edge 71 of the rear cover 7 is greater;

4. Stiffness B is greater than stiffness A:
Curvature of the rear edge 9 of the front cover 6 is flatter and curvature of the front edge 71 of the rear cover 7 is nominal.

On 1: it is not necessary for the stiffnesses A and B and curvatures or convexity of the covers 6 and 7 in the region of the mutually facing cover edges 9 and 71 to be precisely the same or nominal. The term “nominal” curvature in this context refers to a transverse curvature of the vehicle roof, so that the covers are curved for example corresponding to a roof skin contour. As the curvatures of the covers deviate above or below such a nominal curvature, i.e. the covers have a flatter or greater curvature than the roof skin, a targeted prestress may be established if differently curved covers are pressed against one another, so as to bring them into a common “nominal” position which for example is established on closure. A maximum height of such curvature differences, for example in the y0 direction, may be used to ensure a reliable sealing of the seal. The stiffnesses A and B according to 1 are to some extent approximately identical, so that cover movements of the covers 6 and 7, caused amongst others by their cover sizes and weight, take place without significant shifts relative to one another. An upward movement of the covers 6 and 7 is therefore deliberately tolerated insofar as these, and in particular the relative movements, remain within a predefined tolerance range.

On 2: the rear edge 9 of the front cover 6 is designed stiffer than the front edge 71 of the rear cover 7, so that in particular a lifting of the rear edge 9 is prevented or countered. A corresponding position of the rear edge 9 may be predefined by means of associated cover mechanisms.

On 3: the rear edge 9 of the front cover 6 is stiffer than the front edge 71 of the rear cover 7 and, in comparison with previous embodiments, the rear cover 7 has a slightly greater curvature. On closure, the front cover 6 then pulls the rear cover 7 into a predefined nominal position. Due to the greater curvature of the rear cover 7, the cover seal 4 is compressed more greatly in y0 in the retracted position Z1 of the front cover 6 then in previous embodiments, so that in the case of a relative shift of cover edges 6, 71, the seal of the cover system 2 is ensured. Optionally, one more spacers may be provided, for example on a top side of the transverse web 51, in order to prevent over-compression of the cover seal 4.

On 4: the rear edge 9 of the front cover 6 is designed softer than the front edge 71 of the rear cover 7, and is also flatter. On closure, the front cover 6 is tensioned via the rear cover 7 and closed into a predefined nominal position. The cover seal 4 is compressed in y0 more greatly than in previous embodiments, so that in the case of a relative shift between the cover edges 9, 71, the seal of the cover system 2 is ensured. Optionally, one more spacers may also be provided in this configurations, for example on a top side of the transverse web 51, in order to prevent over-compression of the cover seal 4. In addition, the glass pane of the front cover 6 is preferably slightly prestressed to prevent detachment from the glass pane of the rear cover 7.

Because of the described configurations and targeted control of the cover stiffnesses A and B, and the formation of the curvatures of the covers 6 and 7, no additional stiffening elements are required. Because of the compact form of associated cover mechanisms, such as the tilt mechanism 30 and the drive unit 40, the stiffening of the cover or covers 6, 7 can be adapted to the specific bodywork of the motor vehicle. Thus the visibility through the vehicle roof 1 may be considerably increased. A width and height of the joining point between the covers 6, 7 can be substantially reduced by the described possible embodiments of the covers 6, 7 and transverse web 51. Thus an improved visibility and greater headroom may be achieved. In particular, the design of the transverse web 51 as a visible plastic part leads to a very low installation space requirement, since no additional visible trim panels or headlining elements are required. The transverse web 51 may furthermore be made of steel or a hybrid material, or be designed as or comprise an organic sheet containing for example carbon fibers embedded in a plastic matrix.

By separating the deployment mechanisms and rotational point of the front cover 6, a design is possible without front trim panel and guide rails. Thus a particularly good visibility through the covers 6 and 7 and the vehicle roof 1 can be achieved, which customers usually perceive as attractive and comfort-enhancing.

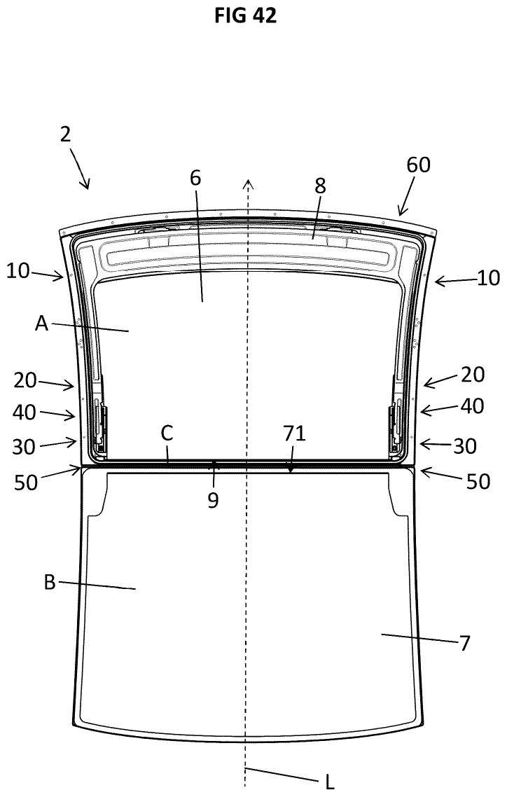

According to a particularly preferred embodiment, the cover system 2—as illustrated in a plurality of figures—comprises at least one cover receiving unit 10, a cover centering unit 20, a tilt mechanism 30, a drive unit 40, a sealing assembly 50 and a stiffening assembly 60 (see FIG. 42). Alternatively, the cover system 2 may however also comprise only one, two, three, four or five of the listed components.

By means of the cover system 2, a panoramic roof can be achieved which in particular allows a top load, front tilt ventilation concept. The cover system 2 may thus be applied from above and coupled to the roof bodywork 5, and combines a ventilation function with maximum visibility through the vehicle roof 1. Alternatively, the cover system 2 may also be configured for installation from below and constitute a so-called “bottom load” system.

The description contains the following concepts:
1. An assembly for a vehicle roof (1) for a motor vehicle, comprising:
   a cover (6) for forming a deployable and retractable roof element for the vehicle roof (1),
   an inner cover panel (13) which is coupled to the cover (6),
   a cover frame (8) which is configured for coupling the cover (6) to a roof bodywork (5) of the motor vehicle,
   a cover receiving unit (10) which is configured for receiving the cover (6) and coupling it to the cover frame (8), and
   a cover centering unit (20) which comprises a centering lever (21) and a lever receiver (22) matched to one another, wherein one of the centering lever (21) and lever receiver (22) is coupled to the cover frame (8) at a side longitudinal web (82) thereof relative to a longitudinal axis (L) of the vehicle roof (1), and the other of the centering lever (21) and lever receiver (22) is coupled to the inner cover panel (13), so that the cover (6) can be coupled to the cover frame (8) by means of the cover receiving unit (10) and centered relative to the cover frame (8) in a main extent plane of the cover (6) by pushing the centering lever (21) into the lever receiver (22), and thereby an aligned and operationally ready state of the assembly can be formed.
2. The assembly according to concept 1, wherein the centering lever (21) is formed integrally with the inner cover panel (13) or the cover frame (8) and is formed as a curved tab.
3. The assembly according to either of the preceding concepts, wherein the lever assembly (21) is sleeve-shaped.
4. The assembly according to any of the preceding concepts, wherein the cover centering unit (20) comprises a vibration-damping element which is coupled to the lever receiver (22) and counters a vibration of the centering lever (21) in the coupled state of the cover (6) with the cover frame (8).
5. The assembly according to concept 4, wherein the vibration-damping element comprises a plastic overmolding which is formed on an inside of the lever receiver (22) facing the centering lever (21), so that the plastic overmolding is arranged between the centering lever (21) and the lever receiver (22) in a coupled state of the cover (6) with the cover frame (8).
6. The assembly according to any of the preceding concepts, wherein the cover (6) is configured as a deployable and retractable roof element which can be raised and lowered at a rear edge (9), wherein the cover receiving unit (10) is arranged on a front transverse web (81) of the cover frame (8) and forms a pivot axis of the cover (6) in a coupled state of the cover (6) with the cover frame (8), and wherein the centering lever (21) and the lever receiver (22) are matched to the pivot axis in orientation, position and/or form.
7. The assembly according to any of the preceding concepts, wherein the cover (6) is configured as a deployable and retractable roof element which can be raised and lowered at a rear edge (9) and has a predefined curvature relative to its main extent plane, wherein the centering lever (21) and the lever receiver (22) are matched to the curvature of the cover (6) in orientation, position and/or form.
8. The assembly according to any of the preceding concepts, wherein the cover receiving unit (10) comprises a receiving element (11) with a receiving opening (16) and a push-fit element (14), wherein the push-fit element (14) and the receiving opening (16) are matched to one another, and one of the receiving element (11) and push-fit element (14) is coupled to the cover frame (8) at a front transverse web (81) thereof relative to the longitudinal axis (L) of the vehicle roof (1), and the other of the receiving element (11) and the push-fit element (14) is coupled to the inner cover panel (13), so that the cover (6) can be coupled to the cover frame (8) by pushing the push-fit element (13) into the receiving opening (16).
9. A method for producing an assembly for a vehicle roof (1) for a motor vehicle, comprising:
   providing a cover (6) and an inner cover panel (13) and a cover frame (8) which is configured for coupling the cover (6) to a roof bodywork (5) of the motor vehicle by means of the inner cover panel (13),
   providing a cover receiving unit (10) which is configured for receiving the cover (6) and coupling it to the cover frame (8),
   providing a cover centering unit (20) with a centering lever (21) and a lever receiver (22), wherein the centering lever (21) and the lever receiver (22) are matched to one another, wherein one of the centering lever (21) and the lever receiver (22) is coupled to the cover frame (8) at a side longitudinal web (82) thereof relative to a longitudinal axis (L) of the vehicle roof (1), and the other of the centering lever (21) and lever receiver (22) is coupled to the inner cover panel (13),
   coupling of the inner cover panel (13) to the cover (6),
   coupling of the cover (6) to the cover frame (8) by means of the cover receiving unit (10),
   pushing of the centering lever (21) into the lever receiver (22) and thereby centering the cover (6) relative to the cover frame (8) in a main extent plane of the cover (6), and forming an aligned and operationally ready state of the assembly.
10. The method according to concept 9, comprising:
   providing the cover receiving unit (10), which comprises a receiving element (11) with a receiving opening (16) and a push-fit element (14), wherein the push-fit element (14) and the receiving opening (16) are matched to one another, and one of the receiving element (11) and push-fit element (14) is coupled to the cover frame (8) at a front transverse web (81) thereof relative to the longitudinal axis (L) of the vehicle roof (1), and the other of the receiving element (11) and the push-fit element (14) is coupled to the inner cover panel (13), and
   coupling the cover (6) to the cover frame (8) by means of the cover receiving unit (10) by pushing the push-fit element (13) into the receiving opening (16).
11. An assembly for a vehicle roof (1) for a motor vehicle, comprising:
   a cover (6) for forming a deployable and retractable roof element for the vehicle roof (1),
   an inner cover panel (13) which is coupled to the cover (6),
   a cover frame (8) which is configured for coupling the cover (6) to a roof bodywork (5) of the motor vehicle, and
   a cover receiving unit (10) which comprises a receiving element (11) with a receiving opening (16) and a push-fit element (14), wherein the push-fit element (14) and the receiving opening (16) are matched to one another, wherein one of the receiving element (11) and push-fit element (14) is coupled to the cover frame (8) at a front transverse web (81) thereof relative to the longitudinal axis (L) of the vehicle roof (1), and the other of the receiving element (11) and the push-fit element (14) is coupled to the inner cover panel (13), so that the cover (6) can be coupled to the cover frame (8) by pushing the push-fit element (13) into the receiving opening (16) and thereby an operationally ready state of the assembly can be formed at the front transverse web (81) of the cover frame (8).
12. The assembly according to concept 11, wherein the receiving element (11) is formed U-shaped in a cross-section along the longitudinal axis (L) of the vehicle roof (1) and forms an insertion pocket for the push-fit element (14).
13. The assembly according to any of the preceding concepts, wherein the push-fit element (14) is formed integrally with the inner cover panel (13) or the cover frame (8) and formed as a curved tab.
14. The assembly according to any of the preceding concepts, having a vibration-damping element (12) which is formed in the region of the receiving opening (16) and exerts a retaining force on the push-fit element (14) inside the receiving opening (16) in a coupled state of the cover (6) with the cover frame (8).
15. The assembly according to concept 14, wherein the vibration-damping element (12) comprises a plastic overmolding which is formed on an inside (17) of the receiving element (11) adjoining the receiving opening (16), so that the plastic overmolding is arranged between the receiving element (11) and the push-fit element (14) in a coupled state of the cover (6) with the cover frame (8).
16. The assembly according to concept 14 or 15, wherein the vibration-damping element (12) comprises a spring element which, in the region of the receiving opening (16), exerts a spring force on the receiving element (11) in the direction of the receiving opening (16).
17. The assembly according to any of the preceding concepts, having a plurality of receiving elements (11) and a plurality of push-fit elements (14), which are each arranged and/or are formed spaced apart along the front transverse web (81) of the cover frame (8), such that respective push-fit elements (14) are pushed into associated receiving elements (11) in a coupled state of the cover (6) with the cover frame (8).
18. A cover system (2) for a vehicle roof (1), comprising:
   an assembly according to any of concepts 11 to 17, and
   a further cover (7), which are coupled to the cover frame (8) so that relative to the longitudinal axis (L) of the vehicle roof (1), the cover (6) forms a front deployable roof element and the further cover (7) forms a rear roof element for the vehicle roof (1).
19. A vehicle roof (1) for a motor vehicle, comprising:
   an assembly according to any of concepts 11 to 17 or a cover system (2) according to concept 18, which is coupled to a roof bodywork (5) of the motor vehicle by means of the cover frame (8).
20. A method for producing an assembly for a vehicle roof (1) for a motor vehicle, comprising:
   providing a cover (6) and an inner cover panel (13), and a cover frame (8) which is configured for coupling the cover (6) to a roof bodywork (5) of the motor vehicle by means of the inner cover panel (13),
   providing a cover receiving unit (10) which comprises a receiving element (11) with a receiving opening (16) and a push-fit element (14), wherein the push-fit element (14) and the receiving opening (16) are matched to one another, wherein one of the receiving element (11) and push-fit element (14) is coupled to the cover frame (8) at a front transverse web (81) thereof relative to the longitudinal axis (L) of the vehicle roof (1), and the other of the receiving element (11) and the push-fit element (14) is coupled to the inner cover panel (13),
   coupling of the inner cover panel (13) to the cover (6), and
   pushing of the push-fit element (14) into the receiving opening (16) and thereby coupling the cover (6) to the cover frame (8) and forming an operationally ready state of the assembly at the front transverse web (81) of the cover frame (8).
21. An assembly for a vehicle roof (1) for a motor vehicle, comprising:
   a cover (6) for forming a deployable and retractable roof element for the vehicle roof (1),
   an inner cover panel (13) which is coupled to the cover (6),
   a cover frame (8) which is configured for coupling the cover (6) to a roof bodywork (5) of the motor vehicle, and
   a cover receiving unit (10) which is configured for receiving the cover (6) and coupling it to the cover frame (8), and
   a tilt mechanism (30) which comprises a deployment lever (31), a sliding block (32) and a sliding block guide (37),
   wherein the deployment lever (31) is firstly coupled pivotably to the sliding block (32) and thereby has a first pivot axis (S1), and wherein the deployment lever (31) is secondly coupled pivotably to the inner cover panel (13) and thereby has a second pivot axis (S2),
   wherein the sliding block (32) is furthermore coupled to the cover frame (8) by means of the sliding block guide (37), so that the sliding block (32) is displaceable relative to the cover frame (8) along a longitudinal axis (L) of the vehicle roof (1), and the cover (6) is adjustable by means of the tilt mechanism (30) between a first retracted position (Z1) and a second deployed position (Z2), and
   wherein the tilt mechanism (30) is configured such that the second pivot axis (S2) is positionally fixed relative to the cover (6), and the first pivot axis (S1) is movable on transition of the cover (6) from the first position (Z1) to the second position (Z2) and is positionally fixed relative to the sliding block (32) on reaching the second position (Z2).
22. The assembly according to concept 21, wherein the deployment lever (31) has a first and a second coupling peg (33, 34), and the sliding block (32) has a first and a second slotted track (35, 36) in which a respective coupling peg (33, 34) of the deployment lever (31) engages, so that the transfer of the cover (6) from the first position (Z1) to the second position (Z2) is track-guided.
23. The assembly according to concept 22, wherein on transfer of the cover (6) from the first position (Z1) to the second position (Z2), the second coupling peg (34) is decoupled from the second slotted track (36) while the first coupling peg (33) remains coupled in the first slotted track (35), and/or wherein, relative to a vertical direction perpendicular to a main extent plane of the cover (6), the second coupling peg (6) is arranged above the first coupling peg (33) on transfer of the cover (6) from the first position (Z1) to the second position (Z2).
24. The assembly according to any of the preceding concepts, wherein the deployment lever (31) has a third coupling peg (39) and the sliding block guide (37) has a slotted track (371) in which the third coupling peg (39) engages, wherein the slotted track (371) of the sliding block guide (37) is delimited in predefined fashion on both sides relative to the longitudinal axis (L) of the vehicle roof (1) and provides a respective end stop for the third coupling peg (39) for forming the first and second positions (Z1, Z2) of the cover (6).
25. The assembly according to any of the preceding concepts, wherein the sliding block (32) can travel along the sliding block guide (37) between a first and a second stop element, wherein the first stop element is formed by a portion of the cover frame (8) and the second stop element is formed by a slide stop (38), and/or wherein the slide stop (38) delimits the slotted track (371) of the sliding block guide (37) on one side.
26. The assembly according to any of the preceding concepts, wherein the sliding block (32) is coupled to a drive unit (40) so as to be drivable directly.
27. The assembly according to any of the preceding concepts, wherein the cover receiving unit (10) comprises a receiving element (11) with a receiving opening (16) and a push-fit element (14), wherein the push-fit element (14) and the receiving opening (16) are matched to one another, and one of the receiving element (11) and push-fit element (14) is coupled to the cover frame (8) at a front transverse web (81) thereof relative to the longitudinal axis (L) of the vehicle roof (1), and the other of the receiving element (11) and the push-fit element (14) is coupled to the inner cover panel (13), so that the cover (6) can be coupled to the cover frame (8) by pushing the push-fit element (13) into the receiving opening (16).
28. The assembly according to any of the preceding concepts, comprising:
   a cover centering unit (20) having a centering lever (21) and a lever receiver (22) matched to one another, wherein one of the centering lever (21) and the lever receiver (22) is coupled to the cover frame (8) at a side longitudinal web (82) thereof relative to a longitudinal axis (L) of the vehicle roof (1), and the other of the centering lever (21) and lever receiver (22) is coupled to the inner cover panel (13), so that the cover (6) can be coupled to the cover frame (8) by means of the cover receiving unit (10) and centered relative to the cover frame (8) in a main extent plane of the cover (6) by pushing the centering lever (21) into the lever receiver (22).
29. An assembly (50) for sealing an intermediate space between two covers (6, 7) for a vehicle roof (1) for a motor vehicle, comprising:
   a cover frame (8) which is configured for coupling a deployable and retractable first cover (6) and a second fixed cover (7) to a roof bodywork (5) of the motor vehicle,
   a cover seal (4) which is configured for sealing a space between the first cover (6) and the cover frame (8),
   an adhesive track (53) which is configured for coupling the second cover (7) to the cover frame (8),
   a transverse web (51) which is coupled to the cover frame (8) on opposite sides relative to a longitudinal axis (L) of the vehicle roof (1), and
   a permanently plastic sealing element (52), wherein the cover seal (4) is coupled to the transverse web (51) at its front side (511), wherein the adhesive track (53) is coupled to the transverse web (51) at its rear side (512) so that the cover seal (4), the adhesive track (53) and the transverse web (51) establish a predefined channel forming a water gully (54) for discharge of water, wherein the cover seal (4) and the adhesive track (53) are furthermore each coupled to the cover frame (8) at a respective edge region (513) of the transverse web (51), and
   wherein the sealing element (52) is arranged in the edge region (513) of the transverse web (51) and is tightly coupled thereto and to the cover frame (8), the cover seal (4) and the adhesive track (53).
30. The assembly (50) according to concept 29, wherein the transverse web (51) comprises an injection channel (56) and an outlet opening (57), via which sealant for forming the sealing element (52) is injected and applied at a predefined position.
31. The assembly (50) according to any of the preceding concepts, wherein the cover frame (8) has a recess forming a sealant receiver (55) in which the sealing element (52) is applied.
32. The assembly (50) according to any of the preceding concepts, wherein the sealing element (52) is made of or comprises butyl.
33. The assembly (50) according to any of the preceding concepts, wherein the transverse web (51) has a plurality of coupling ribs (514), via which the transverse web (51) is connected to the adhesive track (53).
34. The assembly (50) according to any of the preceding concepts, wherein the transverse web (51) is made of plastic or comprises plastic and is configured as a component predefined for the vehicle roof (1), which is visible from a vehicle interior of the motor vehicle.
35. A method for producing an assembly (50) for sealing an intermediate space between two covers (6, 7) for a vehicle roof (1) for a motor vehicle, comprising:
   providing a cover frame (8) which is configured for coupling a deployable and retractable first cover (6) and a second fixed cover (7) to a roof bodywork (5) of the motor vehicle,
   providing a cover seal (4) which is configured for sealing a space between the first cover (6) and the cover frame (8),
   providing a transverse web (51),
   coupling the transverse web (51) to the cover frame so that the transverse web (51) is coupled to the cover frame (8) on opposite sides relative to a longitudinal axis (L) of the vehicle roof (1), and a respective cavity (55) is formed between the transverse web (51) and the cover frame (8),
   arranging the cover seal (4) on a front side (511) of the transverse web (51) and coupling the cover seal (4) to the cover frame (8) at a respective edge region (513) of the transverse web (51),
   applying an adhesive track (53) on a rear side (512) of the transverse web (51) and on the cover frame (8) at a respective edge region (513) of the transverse web (51), so that the cover seal (4), the adhesive track (53) and the transverse web (51) establish a predefined channel forming a water gully (54) for discharge of water, and
   injecting permanently plastic sealant into the respective cavity (55) and forming a respective sealing element (52) which is arranged in the respective edge region (513) of the transverse web (51) and is tightly coupled thereto and to the cover frame (8), the cover seal (4) and the adhesive track (53).
36. The method according to concept 35, wherein the injection of permanently plastic sealant comprises: injecting hot butyl and forming a respective sealing element (52).
37. The method according to concept 35 or 36, wherein the cover seal (4) and/or the adhesive track (53) are coupled to the transverse web (51) and the cover frame (8) before injection of the sealant.
38. The method according to concept 35 or 36, wherein the cover seal (4) and/or the adhesive track (53) are coupled to the transverse web (51) and the cover frame (8) after injection of the sealant, and pressed into the injected sealant.
39. The method according to any of concepts 35, 36 or 38, comprising:
   applying the sealant to the cover frame (8) at opposite positions relative to the longitudinal axis (L), then
   mounting the transverse web (51) on the cover frame (8) and pressing the transverse web (51) into the respective applied sealant, and then
   arranging the cover seal (4) and applying the adhesive track (53), and pressing the cover seal (4) and adhesive track (53) into the respective applied sealant.
40. A cover system (2) for a vehicle roof (1), comprising:
   an assembly (50) according to any of the preceding concepts, and
   a first deployable and retractable first cover (6) and a second fixed cover (7) which are each coupled to the cover frame (8) so that, relative to a longitudinal axis (L) of the vehicle roof (1), the first cover (6) forms a front roof element and the further cover (7) forms a rear roof element for the vehicle roof (1).
41. A cover system (2) for a vehicle roof (1) for a motor vehicle, comprising:
   a first deployable and retractable first cover (6) which has a predefined stiffness (A),
   a second fixed cover (7) which has a predefined stiffness (B),
   a cover frame (8) which is coupled to the two covers (6, 7) and is configured for coupling the covers (6, 7) to a roof bodywork (5) of the motor vehicle,
   a transverse web (51) which has a predefined stiffness (C) and is coupled to the cover frame (8) on opposite sides relative to a longitudinal axis (L) of the vehicle roof (1), and is arranged between a rear edge (9) of the first cover (6) and a front edge (71) of the second cover (7), and
   a stiffening assembly (60) which comprises a U-shaped stiffening frame (62, 62) coupled to the first cover (6), wherein the stiffening frame (61, 62) and the stiffnesses (A, B, C) of the two covers (6, 7) and of the transverse web (51) are matched to one another such that a movement of the cover (6, 7) in the direction of a vertical perpendicular to a respective main extent plane of the first and/or second cover (6, 7) is permitted within a predefined tolerance range.
42. The cover system (2) according to concept 41, wherein the predefined tolerance range comprises a movement of the first cover (6) of up to 10 mm and a movement of the second cover (7) of up to 5 mm in the direction of the vertical perpendicular to a respective main extent plane of the first and/or second cover (6, 7).
43. The cover system (2) according to any of the preceding concepts, wherein the rear edge (9) of the first cover (6) is stiffer than the front edge (71) of the second cover (7), so that the stiffness (A) of the first cover (6) is greater than the stiffness (B) of the second cover (7).
44. The cover system (2) according to concept 41 or 42, wherein the front edge (71) of the second cover (7) is stiffer than the rear edge (9) of the first cover (6), so that the stiffness (A) of the first cover (6) is lower than the stiffness (B) of the second cover (7).
45. The cover system (2) according to any of the preceding concepts, wherein the stiffening assembly (60) comprises a transverse web (61) and two longitudinal webs (62) which are connected to the first cover (6) on opposite sides relative to the longitudinal axis (L), so that the rear edge (9) of the first cover (6) is formed without reinforcement.
46. The cover system (2) according to any of the preceding concepts, wherein in a retracted state (Z1), the first cover (6) is coupled to the transverse web (51) at the rear edge (9) by means of a cover seal (4) which is configured for sealing a space between the first cover (6) and the cover frame (8), and wherein the second cover (7) is coupled to the transverse web (51) at the front edge (71) by means of an adhesive track (53) which is configured for connecting the second cover (7) to the cover frame (7), so that the cover seal (4), adhesive track (53) and transverse web (51) establish a predefined channel which forms a water gully (58) for discharge of water.
47. The cover system (2) according to concept 46, comprising:
   a spacer which is coupled to the transverse web (51) or the first cover (6), and which is configured for countering an over-compression of the cover seal (4) in the retracted state (Z1) of the cover (6).
48. The cover system (2) according to any of the preceding concepts, wherein the transverse web (51) is made of plastic or comprises plastic, so that the stiffness (C) of the transverse web (51) is significantly lower than the stiffnesses (A, B) of the first and second covers (6, 7).
49. The cover system (2) according to any of the preceding concepts, wherein the stiffnesses (A, B) of the covers (6, 7) are predefined, relative to the vertical direction perpendicular to their respective main extent plane, by means of a respective curvature, a respective thickness and/or a respective material of the covers (6, 7).
50. A vehicle roof (1) for a motor vehicle, comprising: an assembly (50) according to any of the preceding concepts or a cover system (2) according to any of the preceding concepts, which is coupled to a roof bodywork (5) of the motor vehicle by means of the cover frame (8).

1. An assembly for a vehicle roof for a motor vehicle, comprising:
a cover for forming a deployable and retractable roof element for the vehicle roof,
an inner cover panel which is coupled to the cover,
a cover frame which is configured for coupling the cover to a roof bodywork of the motor vehicle,
a cover receiving unit which is configured for receiving the cover and coupling it to the cover frame,
a tilt mechanism which is coupled firstly to the inner cover panel and secondly to the cover frame, and which is configured for moving the cover between a first retracted position and a second deployed position, and
an electric drive unit which is coupled directly to the tilt mechanism so that the cover can be electrically moved between the first and second positions by the tilt mechanism and the drive unit without the use of a drive cable.

2. The assembly according to claim 1, wherein the drive unit comprises a spindle drive with a motor and a driving spindle, by means of which the drive unit is coupled directly to the tilt mechanism.

3. The assembly according to claim 1, wherein the drive unit comprises a gear mechanism, by means of which the drive unit can be coupled directly to the tilt mechanism.

4. The assembly according to claim 1, wherein the tilt mechanism and the drive unit are mounted in a common holder.

5. The assembly according to claim 1, wherein the drive unit forms a separate assembly which is attached to a mounting of the tilt mechanism.

6. The assembly according to claim 1, wherein the drive unit is coupled to the cover frame at a side longitudinal web thereof relative to a longitudinal axis of the vehicle roof.

7. The assembly according to claim 1, wherein the tilt mechanism comprises a deployment lever, a sliding block and a sliding block guide,
wherein the deployment lever is firstly coupled pivotably to the sliding block and thereby has a first pivot axis, and wherein the deployment lever is secondly coupled pivotably to the inner cover panel and thereby has a second pivot axis,
wherein the sliding block is furthermore coupled to the cover frame by means of the sliding block guide so that the sliding block is configured so as to be displaceable relative to the cover frame along a longitudinal axis of the vehicle roof, and wherein the tilt mechanism is configured such that the second pivot axis is positionally fixed relative to the cover, and the first pivot axis is movable on transition of the cover from the first position to the second position and is positionally fixed relative to the sliding block on reaching the second position.

8. The assembly according to claim 7, wherein the drive unit is coupled directly to the sliding block of the tilt mechanism.

9. A cover system for a vehicle roof, comprising:
an assembly according to claim 1, and
a further cover which is coupled to the cover frame so that, relative to a longitudinal axis of the vehicle roof, the cover forms a front roof element and the further cover forms a rear roof element for the vehicle roof.

10. The cover system according to claim 9, comprising:
a further assembly according to any of claims 1 to 8 claim 1, wherein the two assemblies are coupled to the roof frame on opposite sides relative to the longitudinal axis of the vehicle roof.

11. A vehicle roof for a motor vehicle, comprising:
an assembly according to claim 1, which is coupled to a roof bodywork of the motor vehicle by means of the cover frame.
